(19) United States
(12) Patent Application Publication
(10) Pub. No.: US 2014/0100679 A1
(43) Pub. Date: Apr. 10, 2014

(54) EFFICIENT SHARING OF INTERMEDIATE COMPUTATIONS IN A MULTIMEDIA GRAPH PROCESSING FRAMEWORK

(71) Applicant: DALET DIGITAL MEDIA SYSTEMS, Levallois-Perret (FR)

(72) Inventors: Oran Gilad, Modi'in (IL); Ortal Zeevi, London (GB)

(73) Assignee: DALET DIGITAL MEDIA SYSTEMS, Levallois-Perret (FR)

(21) Appl. No.: 13/648,284

(22) Filed: Oct. 10, 2012

(51) Int. Cl. G06F 17/00

(52) U.S. Cl. 700/94

(57) ABSTRACT

An audio processing system including filters configured to process audio buffers, to retrieve auxiliary data from at audio buffers, and to store auxiliary data in audio buffers, concatenators configured to transmit audio buffers from one filter to another filter, to retrieve audio buffers from a shared buffer cache, and to store audio buffers in the shared buffer cache, a processing graph configured to transmit audio buffers processed by filters in the graph from one filter to another filter in accordance with the concatenators, and a graph processor, for applying the processing graph to audio buffers extracted from an incoming audio stream, for storing intermediate processing results of the filters as auxiliary data in audio buffers, and for storing the audio buffers that include auxiliary data in a buffer cache that is shared among the filters.

### FIELD OF THE INVENTION

The present invention relates to production of audio for broadcast.

### BACKGROUND OF THE INVENTION

Conventional computer-based digital audio editing systems process digital audio signals received from various audio input devices and from audio files. The processing includes displaying audio stream properties along a timeline, cutting and combining audio tracks, mixing multiple tracks into a single signal, applying digital effects such as volume amplification or attenuation, pitch modification, echo and noise reduction, routing mixed audio tracks to audio output devices, and rendering complex editing projects into digital audio files. Nearly all conventional audio editing systems rely on a software architecture based on a graph of digital audio filters.

Filters are basic software components that receive as input a specific number of streams of digital audio encoding, and generate as output a number of digital signals. One commonly used filter is a “multiplexer” that combines a number of decoded uncompressed elementary audio streams and outputs a single stream containing a mix of the two elementary streams. Another commonly used filter is a “demultiplexer” that receives as input an audio file in a specific file wrapper and audio encoding algorithm, and outputs a number of elementary encoded audio streams. Demultiplexers are generally used with file wrappers that interleave multiple audio streams in a single audio file. Yet other commonly used filers apply complex audio transformations, such as high-frequency elimination or noise reduction.

A complex editing project guides the software to internally build a graph of filters, where the output of one filter is piped to the input of a next filter, according to a desired chain of processing instructions. A typical media processing graph of this type includes dozens of filters. A key constraint of the software architecture is that all filters within the graph must be synchronized according to a shared clock, and must process media samples at a fixed sample rate, such as 48,000 samples per second. The quality criteria of a set of filters arranged in a graph are (i) the latency that the graph processing introduces; i.e., how long does it take for one sample to traverse from entry in the graph until exit from the graph, (ii) synchronization; i.e., samples must reach various filters at the same time, and (iii) consistency with deadline; i.e., samples must be processed within a delay that allows the next samples to be processed in real time. As such, it is challenging to develop high-quality digital audio filters.

It would thus be of advantage to have a software architecture that simplifies the work of digital audio filter developers, and improves overall efficiency of graph processing.

### SUMMARY OF THE DESCRIPTION

Aspects of the present invention provide a software architecture that simplifies the work of digital audio filter developers, and improves overall efficiency of graph processing, by eliminating duplicate computations across the graph and by reducing overall graph latency.

According to embodiments of the present invention, data buffers exchanged among connected filters within a graph are managed by a single centralized graph manager component. The graph manager uses efficient memory allocation, and re-allocation of data buffers, thus relieving the filters of this complex task, and enables filters to retrieve digital audio properties that were already computed by another filter, without having to re-compute these same properties.

For example, a low-pass filter computes the Fourier transform of an incoming audio stream in order to generates the filter's output stream. Such computation follows an extensive algorithm that produces auxiliary data that encodes the frequency spectrum of an incoming steam of digital audio samples. Many other filters require this auxiliary data. Using the present invention, downstream filters within the graph are able to re-use the data buffers containing this auxiliary data without re-computing it, and without allocating additional RAM to store the auxiliary data within the filter itself.

As a result, each filter benefits from computations performed previously by other filters, and overall graph processing requires less memory and proceeds with less latency vis-à-vis graph frameworks that do not benefit from the present invention.

There is thus provided in accordance with an embodiment of the present invention a system for processing audio, including a filter instantiator, for instantiating at least one filter, wherein each filter is configured to process at least one audio buffer wherein an audio buffer includes raw audio data and auxiliary data, to retrieve auxiliary data from at least one audio buffer, and to store auxiliary data in at least one audio buffer, a concatenator instantiator, for instantiating at least one concatenator, wherein each concatenator is configured to transmit at least one audio buffer from one filter to another filter, to retrieve at least one audio buffer from a shared buffer cache, and to store at least one audio buffer in the shared buffer cache, a processing graph instantiator, for instantiating a processing graph including the at least one filter instantiated by the filter instantiator and the at least one concatenator instantiated by the concatenator instantiator, wherein the processing graph is configured to transmit audio buffers processed by filters in the graph from one filter to another filter in accordance with the at least one concatenator, and a graph processor, (i) for applying the processing graph instantiated by the processing graph instantiator to at least one audio buffer extracted from an incoming audio stream, (ii) for storing intermediate processing results of at least one of the filters as auxiliary data in at least one audio buffer, and (iii) for storing at least one of the audio buffers that include auxiliary data stored therein by filters, in a buffer cache that is shared among the filters in the processing graph.

There is additionally provided in accordance with an embodiment of the present invention a non-transient computer-readable storage medium for storing instructions which, when executed by a computer processor, cause the processor to instantiate at least one filter, wherein each filter is configured to process at least one audio buffer wherein an audio buffer includes raw audio data and auxiliary data, to retrieve auxiliary data from at least one audio buffer, and to store auxiliary data in at least one audio buffer, to instantiate at least one concatenator, wherein each concatenator is configured to transmit at least one audio buffer from one filter to another filter, to retrieve at least one audio buffer from a shared buffer cache, and to store at least one audio buffer in the shared buffer cache, to instantiate a processing graph including the at least one instantiated filter and the at least one instantiated concatenator, wherein the processing graph is configured to transmit audio buffers processed by filters in the graph from one filter to another filter in accordance with the at least one concatenator, to extract at least one audio buffer from an incoming audio stream, to apply the instantiated processing graph to the at least one extracted audio buffer, to store intermediate processing results of at least one of the filters as auxiliary data in at least one audio buffer, and to store at least one of the audio buffers that include auxiliary data stored therein by filters, in a buffer cache that is shared among the filters in the processing graph.

### BRIEF DESCRIPTION OF THE DRAWINGS

The present invention will be more fully understood and appreciated from the following detailed description, taken in conjunction with the drawings in which:

FIG. 1 is a simplified block diagram of a system for processing audio data, in accordance with an embodiment of the present invention;

FIG. 2 is a simplified flowchart of a method for processing audio data, in accordance with an embodiment of the present invention;

FIG. 3 is a simplified block diagram of serial data sharing, whereby a filter generates auxiliary data and stores it in a buffer, and another filter uses the auxiliary data instead of re-calculating the auxiliary data, in accordance with an embodiment of the present invention;

FIG. 4 is a simplified flowchart of operation of a filter that implements serial data sharing, in accordance with an embodiment of the present invention;

FIG. 5 is a simplified block diagram of parallel data sharing, whereby a concatenator stores a buffer in a buffer cache, and another concatenator uses the cached buffer instead of processing data though a next filter, in accordance with an embodiment of the present invention;

FIG. 6 is a simplified flowchart of operation of a concatenator that implements parallel data sharing, in accordance with an embodiment of the present invention; and

FIG. 7 is a simplified drawing of a graph architecture with filters and concatenators, in accordance with an embodiment of the present invention.

### LIST OF APPENDICES

APPENDIX A is a detailed object-oriented interface for implementing buffers, in accordance with an embodiment of the present invention;

APPENDIX B is a detailed object-oriented interface for implementing filters, in accordance with an embodiment of the present invention;

APPENDIX C is a detailed object-oriented interface for implementing concatenators, in accordance with an embodiment of the present invention; and

APPENDIX D is a detailed object-oriented interface for implementing processing graphs, in accordance with an embodiment of the present invention.

### DETAILED DESCRIPTION

Aspects of the present invention provide a software architecture that simplifies the work of digital audio filter developers, and improves overall efficiency of graph processing, by eliminating duplicate computations across the graph and by reducing overall graph latency.

According to an embodiment of the present invention, data buffers exchanged among connected filters within a graph are managed by a single centralized graph manager component. The graph manager uses efficient memory allocation, and re-allocation of data buffers, thus relieving the filters of this complex task, and enables filters to retrieve digital audio properties that were already computed by another filter, without having to re-compute these same properties.

For example, a low-pass filter computes the Fourier transform of an incoming audio stream in order to generates the filter's output stream. Such computation follows an extensive algorithm that produces auxiliary data that encodes the frequency spectrum of an incoming steam of digital audio samples. Many other filters require this auxiliary data. Using the present invention, downstream filters within the graph are able to re-use the data buffers containing this auxiliary data without re-computing it, and without allocating additional RAM to store the auxiliary data within the filter itself.

As a result, each filter benefits from computations performed previously by other filters, and overall graph processing requires less memory and proceeds with less latency vis-à-vis graph frameworks that do not benefit from the present invention.

Embodiments of the present invention implement serial data sharing and parallel data sharing.

### Serial Data Sharing

Each filter is, on the one hand, an independent modular block. On the other hand, using serial data sharing, auxiliary data processed by the filter is recorded in a shared buffer that is passed serially from one filter to another. Each filter thus has access to the auxiliary data generated by a previous filter. Examples of auxiliary data include inter alia conversion from 16-bit to floating point types, conversion from spatial to frequency domain, extracting ancillary data, and determining where compressed frames start and end. Using the present invention, such auxiliary data need be generated only once.

### Serial Data Sharing—Examples

I. Fast Fourier Transform (FFT)

Applying the FFT is a computationally intensive time consuming process. By storing the FFT as buffer auxiliary data, it is only necessary to compute it once. Processes that apply the FFT include inter alia sample rate conversion, decoding lossy compression such as MPEG and AAC, publishing buffer equalization data, low/high pass filtering, and pitch shifting. Each of these processes requires filters that generally apply the FFT. If more than one of these processes is used within the same graph, then by use of serial data sharing the second and subsequent FFT applications are obviated.

II. Energy Summing

Energy summing is the process of scanning a buffer energy curve and generating its statistics, including inter alia its maximum and its average. Scanning the energy buffer entails iterating through all of its samples, and is a computationally intensive operation. By storing the energy summing statistics as buffer auxiliary data, it is only necessary to compute them once. Processes that apply energy summing include inter alia exposing playback meters for visualization, creating ancillary energy files such as files required to visualize a wave form, calculating RMS/PPM for normalization so as to change the volume of one segment to match the volume of another segment, silence detection when volume is below a threshold, and clipping detection when volume is above a threshold. Each of these processes requires filters that generally apply energy summing. If more than one of these processes is used within the same graph, then by use of serial data sharing the second and subsequent energy summing applications are obviated.

III. Data Compression Packaging

Data compression uses pre-defined structures, as specified by standards bodies such as ISO. When an audio stream is parsed, the detected structure of each of the compressed bit-stream portions may be stored as buffer auxiliary data. Processes that use this auxiliary data include inter alia administrative filters, which resize or trim buffers and use this data to know when to cut a compressed stream, and index generators, which create tables that map each sample to its associated location in a compressed stream. If more than one of these processes is used within the same graph, then by use of serial data sharing the second and subsequent derivations are obviated.

### Parallel Data Sharing

Using parallel data sharing, filters along one path in the graph are able to skip processing that was already performed on a parallel path of the graph, or by filters of another graph. For example, if a 44.1 KHz stream has to be converted into both a 48 KHz linear file and a 48 KHz MP3 file, a user does not have to build smart filter chains to avoid repeating the sample-rate conversion. Instead, sample rate conversion that was performed along one path in the graph is used for a parallel path.

### Parallel Data Sharing—Examples

I. Decoding

There are many processes that require decoding an audio file, including inter alia playback, wave form representation, and finding a specific location that matches a given audio pattern. Different applications may use different graphs that share a common parallel cache. By use of parallel data sharing, the need for a graph to decode part of an audio file that another graph already decoded beforehand is eliminated.

II. Sample Rate Conversion

Often different filters apply the same sample rate conversion of the same buffer slice, such as when converting or recording into multiple destinations where some of the destinations share a common sample rate which is different that the source sample rate. In such case, if a filter has already converted the sample rate of an audio slice, then by use of parallel data sharing subsequent filters to do the same conversion may be skipped.

III. Storage/Network Access

Since storage and network data access is time consuming, it is of advantage to reuse a buffer that was already retrieved. Thus if one module plays audio and another module draws a representation of its wave form in the screen, and another module detects where the audio is to be clipped, then by use of parallel data sharing the need for storage and network access more than once for the same audio portion is eliminated.

IV. Effect Assignment

It is often required to assign the same effect to an audio stream multiple times. For example, a playback graph may assign a compressor effect to a stream, and a waveform drawing graph may also assign the compressor effect in order to visualize on the screen the impact of that effect. By use of parallel data sharing, there is no need to apply the effect twice, since both graphs share a common cache.

In accordance with one embodiment, the present invention uses central resource allocation; i.e., memory allocation is managed by a centralized manager, which releases unnecessary memory in background and allocates new memory on demand. As such, redundant usage of RAM and multiple RAM allocations and de-allocations are avoided.

In accordance with another embodiment, non-central resource allocation is used instead to allocate and de-allocate memory for data buffers, while still implementing serial and parallel data sharing.

The present invention achieves significant performance gains vis-à-vis conventional audio editing systems. Using the present invention, it is possible to perform mufti-resolution recording, sample rate converting and multiple effect chaining, at on-air time, without loss of quality and without degradation of response time. Using the present invention, it is possible to perform decoding, sample rate conversion, stretching and mixing for mufti-channel continuous recording and broadcasting.

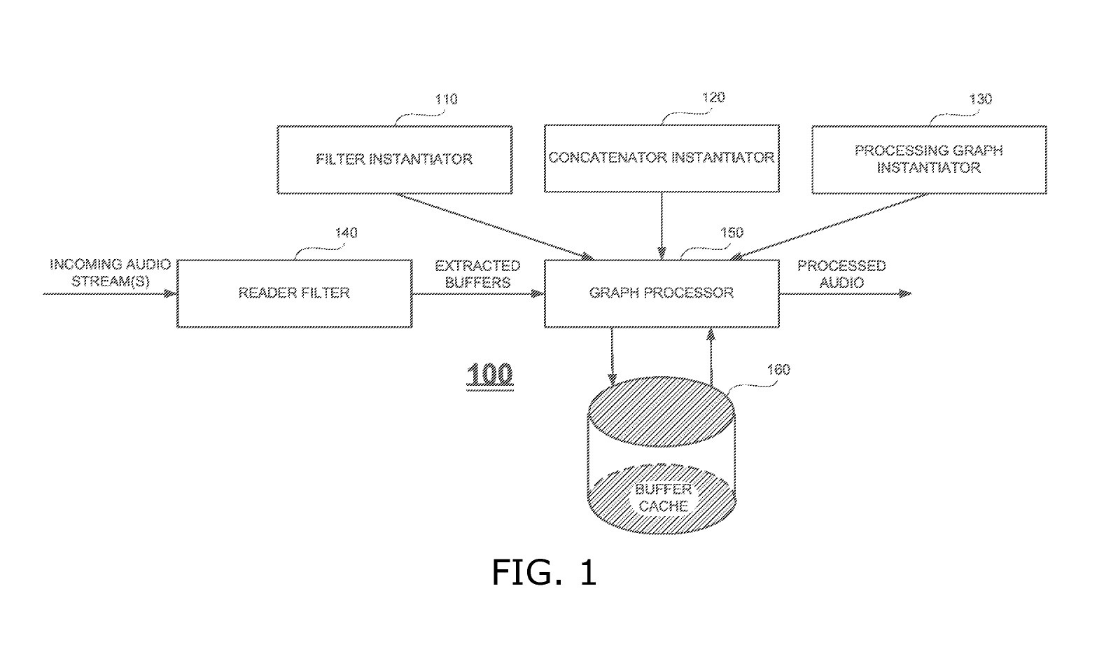

Reference is made to FIG. 1, which is a simplified block diagram of a system 100 for processing audio data, in accordance with an embodiment of the present invention. As seen in FIG. 1, system 100 includes a filter instantiator 110, a concatenator instantiator 120, a processing graph instantiator 130, a reader filter 140, a graph processor 150, and a shared buffer cache 160.

Filter instantiator 110 instantiates at least one filter, wherein each filter is configured to process at least one audio buffer, to retrieve auxiliary data from at least one audio buffer, and to store auxiliary data in at least one audio buffer. An audio buffer includes raw audio data and auxiliary data.

Concatenator 120 instantiates at least one concatenator, wherein each concatenator is configured to transmit at least one audio buffer from one filter to another filter, to retrieve at least one audio buffer from buffer cache 160, and to store at least one audio buffer in buffer cache 160.

Processing graph instantiator 130 instantiates a processing graph including the at least one filter instantiated by filter instantiator 110 and the at least one concatenator instantiated by concatenator instantiator 120. The processing graph is configured to transmit audio buffers processed by filters in the graph from one filter to another filter in accordance with the at least one concatenator.

Reader filter 140 extracts at least one audio buffer from an incoming audio stream.

Graph processor 150 applies the processing graph instantiated by processing graph instantiator 130 to the at least one audio buffer extracted by reader filter 140. Graph processor 150 stores intermediate processing results of at least one of the filters as auxiliary data in at least one audio buffer. Graph processor 150 stores at least one of the audio buffers, which include auxiliary data stored therein by filters, in buffer cache 160, which is shared among the filters in the processing graph.

Operation of filter instantiator 110, concatenator instantiator 120, processing graph instantiator 130, reader filter 140, and graph processor 150 is described below in conjunction with the listings in the appendices.

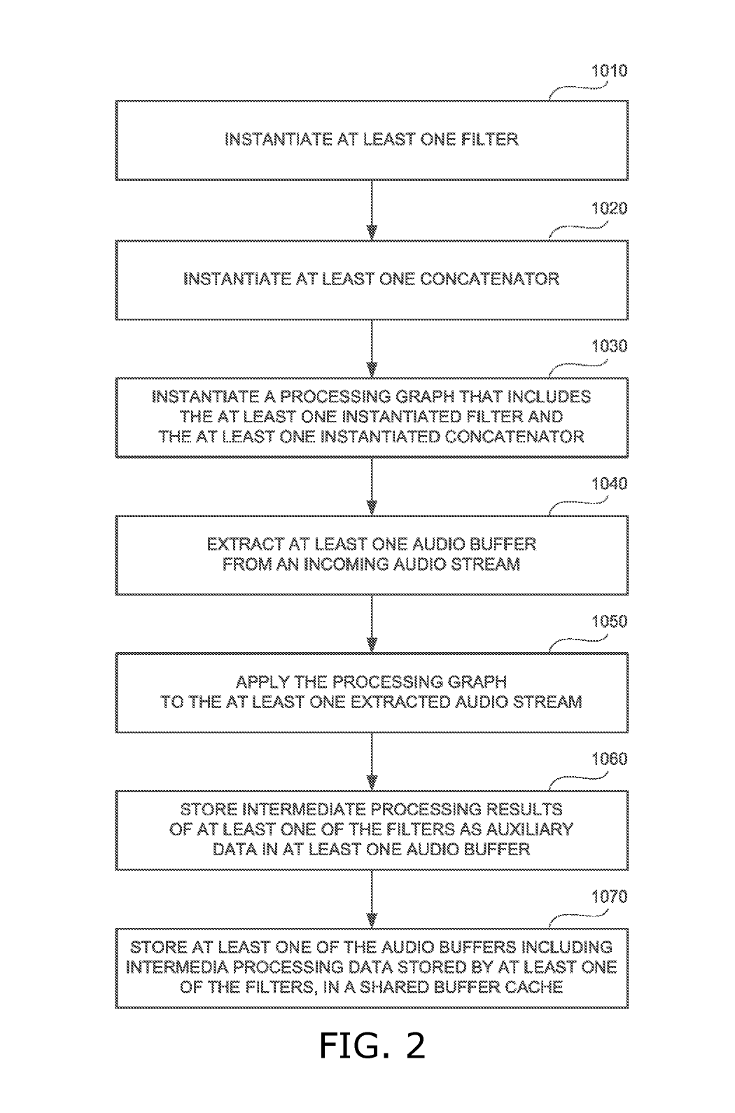

Reference is made to FIG. 2, which is a simplified flowchart of a method for processing audio data, in accordance with an embodiment of the present invention. The flowchart of FIG. 2 is performed by a computer processor, via instructions stored in a computer memory that are executed by the processor. At operation 1010, the computer processor instantiates at least one filter. Each instantiated filter is configured to process at least one audio buffer, to retrieve auxiliary data from at least one audio buffer, and to store auxiliary data in at least one audio buffer. As indicated hereinabove, an audio buffer includes both raw audio data and auxiliary data.

At operation 1020, the computer processor instantiates at least one concatenator. Each instantiated concatenator is configured to transmit at least one audio buffer from one filter to another filter, to retrieve at least one audio buffer from a shared buffer cache, and to store at least one audio buffer in the shared buffer cache.

At operation 1030, the computer processor instantiates a processing graph that includes the at least one filter. The processing graph includes the at least one instantiated filter and the at least one instantiated concatenator. The processing graph is configured to transmit audio buffers processed by filters in the graph from one filter to another filter, in accordance with the at least one connection.

At operation 1040, the computer processor extracts at least one audio buffer from an incoming audio stream.

At operation 1050, the computer processor applies the processing graph to the at least one extracted audio buffer.

At operation 1060, the computer processor stores intermediate results of at least one of the filters as auxiliary data in at least one audio buffer.

At operation 1070, the computer processor stores at least one of the audio buffers that have auxiliary data stored by at least one of the filters, in a buffer cache that is shared among filters of the processing graph, for subsequent use by those filters.

Implementation details for the flowchart of FIG. 2 are provided below and in conjunction with the listings in the appendices.

It will be appreciated by those skilled in the art that one of the many advantages of system 100 is that the processing graph instantiated at operation 1030 may be dynamically updated on-the-fly. New filters and concatenators may be added to the graph, existing filters and concatenators may be removed from the graph, and filters and concatenators may themselves be changed on-the-fly, thereby generating an updated processing graph. Moreover, the updated processing graph is dynamically applied on-the-fly at operation 1050 to subsequent extracted audio buffers. It will also be appreciated by those skilled in the art that new filters may generate new types of auxiliary data, which is stored in the buffer cache at operation 1070 for subsequent use by filters in the processing graph.

Moreover, when new filters are incorporated, new types of auxiliary data are introduced. The plugin architecture described in Appendices A-D advantageously provides a simple mechanism to extend system 100 to include new filters, new concatenators, and to apply serial and parallel data sharing to new types of auxiliary data.

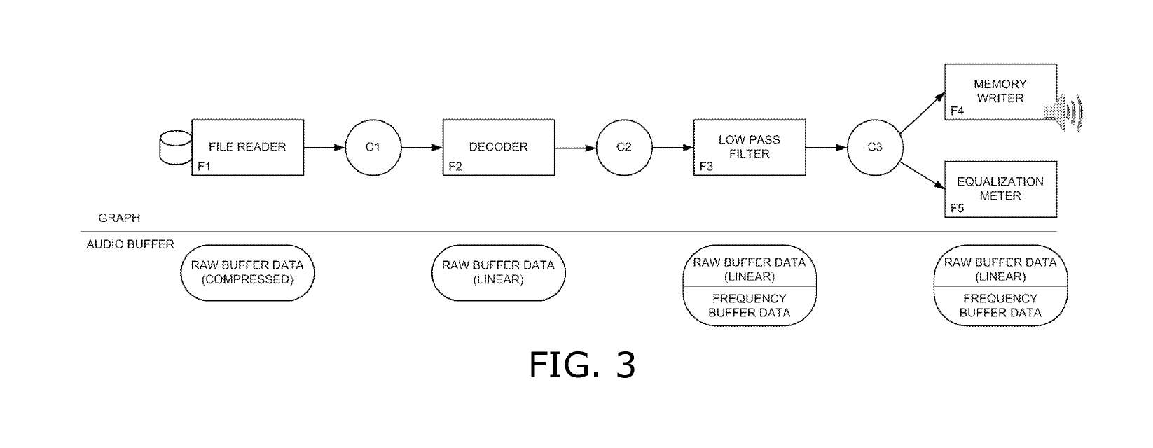

Reference is made to FIG. 3, which is a simplified block diagram of serial data sharing, whereby a filter generates auxiliary data and stores it in a buffer, and another filter uses the auxiliary data instead of re-calculating the auxiliary data, in accordance with an embodiment of the present invention. Shown in FIG. 3 is a graph with five filters, F1-F5. The graph reads a file stored on a storage device, decodes the file, and filters the decoded file with a low-pass filter to remove high-frequency bands. The stream is played out through a sound card, and a GUI equalizer is used to visualize the stream's energy bands.

Filter F1 is a file reader. Filter F1 reads the first buffer from the storage. At this stage, the buffer includes only raw audio data. Concatenator C1 transmits the buffer to filter F2. Filter F2 is a decoder. Filter F2 decodes the buffer, replacing compressed audio data with linear audio data. Concatenator C2 transmits the buffer to Filter F3. Filter F3 is a low pass filter. Filter F3 applies a Fast Fourier Transform on the buffer, which cuts off high frequency bands. The frequency domain data is stored in the buffer. Concatenator C3 transmits the buffer to filter F4 and filter F5. Filter F4 is a memory writer, which stores the data in a memory shared with a sound card driver. Filter F5 is a graphics equalizer that displays the energy bands in a graphical user interface. Filter F5 requires frequency domain data for its operation. Since the frequency domain data already exists in the buffer, it is not necessary for filter F5 to apply the Fast Fourier Transform again. Instead, filter F5 re-uses the frequency domain data already available in the buffer.

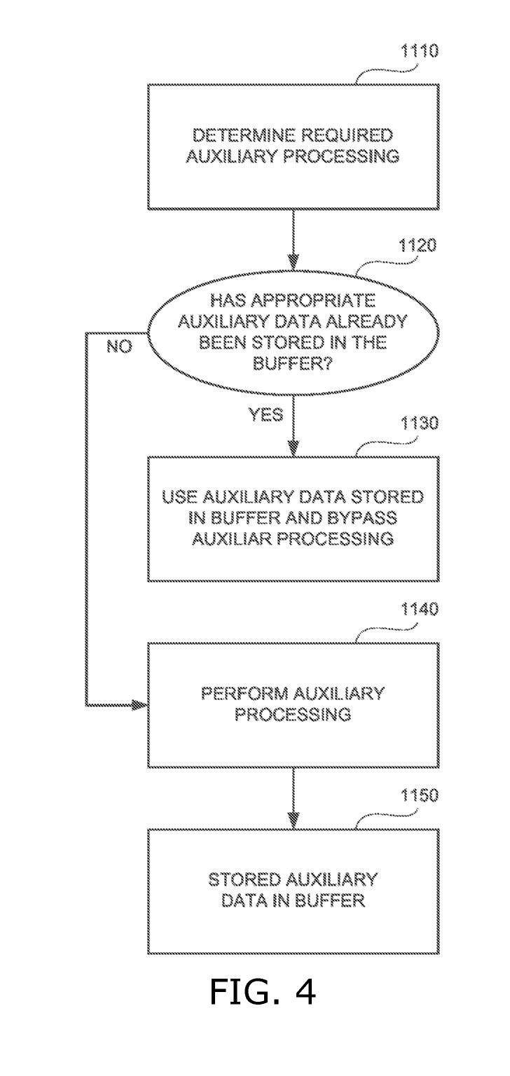

Reference is made to FIG. 4, which is a simplified flowchart of operation of a filter that implements serial data sharing, in accordance with an embodiment of the present invention. At operation 1110 a filter determines what auxiliary processing it requires for an audio buffer. At operation 1120 the filter determines if auxiliary data corresponding to the output of the auxiliary processing, is already stored in the audio buffer. If so, then at operation 1130 the filter uses the auxiliary data stored in the buffer and bypasses the auxiliary processing. If not, then at operation 1140 the filter performs the required auxiliary processing. At operation 1150 the filter stores the results of the auxiliary processing as auxiliary data in the audio buffer.

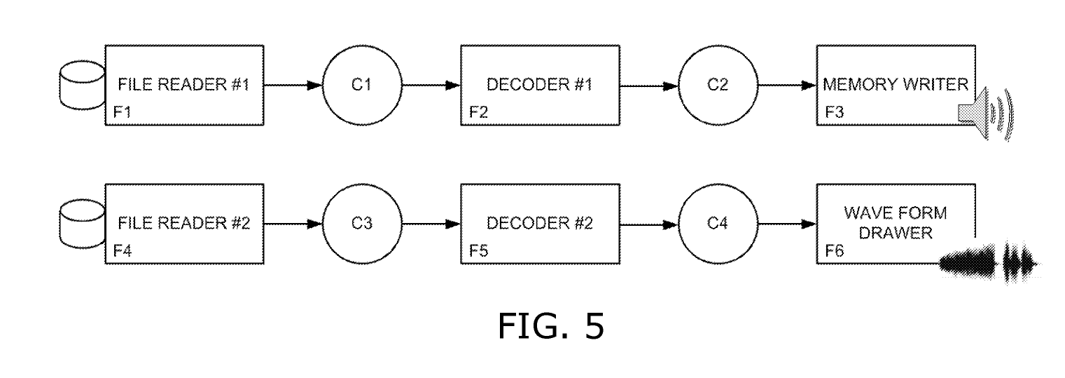

Reference is made to FIG. 5, which is a simplified block diagram of parallel data sharing, whereby a concatenator stores a buffer in a buffer cache, and another concatenator uses the cached buffer instead of processing data though a next filter, in accordance with an embodiment of the present invention. Shown in FIG. 5 are two graphs. A first graph includes filters F1-F3 and concatenators C1 and C2. The first graph is used to read data from a storage, decode the data, and send the data to a sound card. A second graph includes filters F4-F6 and concatenators C3 and C4. The second graph is used to read the same data from the storage, decode the data, and display the data's waveform on a display.

Filter F1 reads a first audio buffer from storage. At this stage, the buffer includes only raw data. Concatenator C1 transmits the buffer to filter F2. Filter F2 is a decoder, which decodes the buffer and replaces the compressed audio data with linear audio data. Concatenator C2 stores the audio buffer in buffer cache 160, and also transmits the buffer to filter F3. Filter F3 is a memory writer, which stores the data in a memory that is shared with a sound card driver.

Since buffer cache 160 is accessible to all concatenators, concatenator C4 detects that a cached buffer corresponds to the expected output from filter F5, which is a decoder. As such, concatenator C4 is able to bypass filter F4, which is a file reader, and to bypass filter F5, and to use the cached buffer instead. I.e., concatenator C4 retrieves the cached buffer and transmits it to filter F6, which is a waveform drawer.

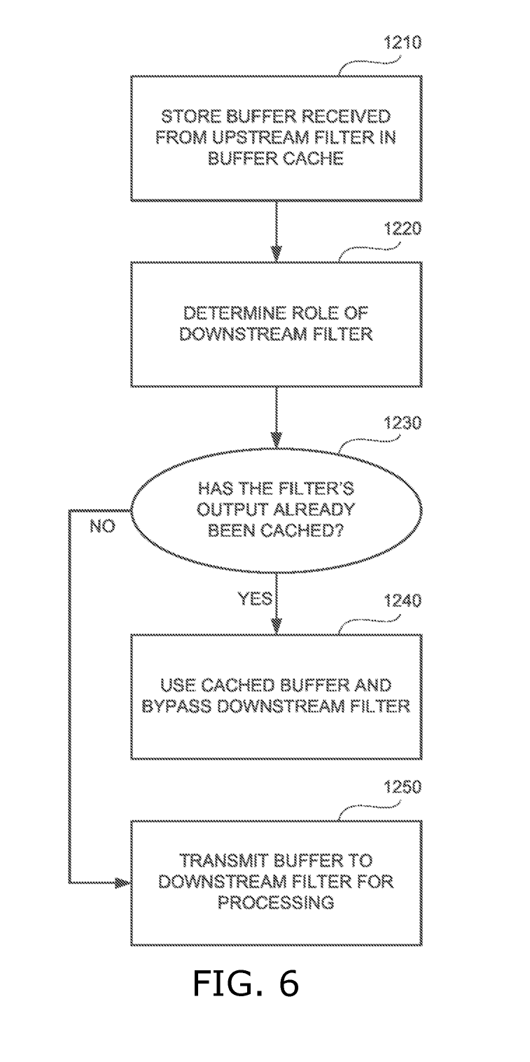

Reference is made to FIG. 6, which is a simplified flowchart of operation of a concatenator that implements parallel data sharing, in accordance with an embodiment of the present invention. An incoming filter for a concatenator is referred to as an upstream filter, and an outgoing filter for a concatenator is referred to as a downstream filter. If the concatenator has one or more upstream filters, then at operation 1210 the concatenator stores the buffer it receives from each upstream filter in a buffer cache, such as buffer cache 160 (FIG. 1). If the concatenator has one or more downstream filters, then at operation 1220 the concatenator determines, for each downstream filter, the role of the filter. The concatenator may inspect each downstream filter using that filter's interface API. At operation 1230 the concatenator determines if the output of a downstream filter has already been cached in the buffer cache. If so, then at operation 1240 the concatenator bypasses the downstream filter and uses instead the appropriate buffer from the buffer cache, corresponding to the output of the filter being bypassed. If not, then at operation 1250 the concatenator transmits its buffer to the downstream filter for processing.

### Implementation Details

In accordance with an embodiment of the present invention, a plugin architecture is provided to enable simple expansion to accommodate new filters, new concatenators and new types of auxiliary data.

In one embodiment, the present invention is implemented by object-oriented program code stored in memory which, when executed by a computer processor, instantiates “buffers”, “filters”, “concatenators” and “graphs” for processing audio streams.

A digital stream includes blocks referred to as buffers, where each buffer represents a partial range of the stream. Each buffer is an object that wraps raw media data, together with auxiliary data that is not part of the raw data, including (i) meta-data, (ii) intermediate processing results that may be shared with other filters, and (iii) “buffer events” to be signaled when buffer processing reaches a designated stage. By sharing data in a buffer, other filters can benefit from the processing already performed by a previous filter, and avoid repeating the same processing.

A buffer event is a handle with an offset within a buffer. At various locations within a graph, a “buffer events stamper” filter may stamp a buffer with an event. At other locations with the graph, a “buffer events signaler” filter signals a buffer event when the corresponding handle location within the buffer is processed. As such, a buffer event may be used to synchronize other parts of a graph, or modules outside the scope of a graph, with a current processing stage. E.g., a buffer event may correspond to certain data starting to be played. A buffer events stamper stamps the buffer within an event corresponding to the first sample of the data. When this first sample is processed by a sound card, a buffer events signaler signals the event. Similarly, a buffer event may correspond to writing the last sample of a recorded file.

Buffers may be locked for read and for write. A buffer may be in various states, including (i) a free state, in which the buffer is clean and not in use, (ii) a write locked state, in which the buffer is locked for writing, (iii) a read locked state, in which the buffer cannot be edited, and (iv) a to-be-deleted state, in which the buffer is in the process of being deleted. When a filter requests a new buffer, the buffer is provided in a write locked state. When the filter finishes processing the buffer, and the buffer is passed to a next filter, the buffer's state is changed to a read locked state.

Buffers are allocated in accordance with a dynamic central “buffer pool”. A buffer pool object includes a list a “buffer lists”, each buffer list including a list of discrete buffers. The buffer pool is shared among all filters of a graph. The hierarchy of buffer pools, buffer lists and discrete buffers enables optimized allocation. Buffers in the same buffer list conform to the same format/encoding parameters, and are of the same size. As such, if a buffer of a designated size and format is required, the buffer pool readily ascertains if such a buffer may be used, by categorizing the buffers into lists.

A buffer cache is used to store previously processed buffers, to avoid their being re-processed. Parallel filter concatenators share a common buffer cache. Each filter concatenator is able to add a buffer to the buffer cache, which may then be retrieved by another filter concatenator.

Reference is made to APPENDIX A, which is a detailed object-oriented interface for implementing buffers, in accordance with an embodiment of the present invention.

A filter processes one or more buffers. The filter receives one or more buffers as input, processes them, and produces one or more buffers as output. There are five types of filters; namely, “base filters”, “administrative filters”, “processing filters”, “edge filters” and “middle filters”. Base filters are generic classes that implement the common functionality of the derived classes. Administrative filters do not process contents of buffers, but instead maintain functionality of a graph. E.g., an administrative filter may split large buffers into smaller chunks, and another administrative filter may pause a graph from reading a file until the file is ready. Processing filters modify data in buffers. Examples of processing filters include encoders, decoders, sample rate convertors, and various audio effects. Edge filters are located on the edge of a graph and, as such, are only connected to the graph through their input or output, but not both. Examples of edge filters include “reader filters” and “writer filters”. Reader filters read buffers from a file, from memory or from other storage means. Writer filters dump buffers into a file, into a memory location, or into other storage means. Middle filters are located in the interior of a graph and, as such, are connected to the graph through both their input and output. Middle filters generally operate in three stages; namely, (i) a buffer is injected into the filter, (ii) the buffer is processed by the filter, and (iii) the buffer is ejected out of the filter.

Wrapper filters are filters that encapsulate one or more filters together. Generally, a wrapper filter functions as a sub-graph; i.e., it contains a subset of the filters in a graph which together perform a joint functionality. Examples of wrapper filters include a pre-mix phase of a playback graph, and a write scope of a recording graph. There are three types of wrapper filters; namely, a “reader wrapper”, a “writer wrapper” and a “middle wrapper”. A reader wrapper is a filter that wraps one or more filters that logically perform an input reading function. An example reader wrapper is a “recording data reader”, i.e., a set of filters that perform a workflow from a recording drive until achievement of a specific requirement. Another example reader wrapper is a “track reader”, which encapsulates all buffers with data fetched from a file until the tracks are mixed. Yet another example reader wrapper is an “any file reader”, which reads data in any given format. A writer wrapper is a filter that wraps one or more filters that logically perform an output writing function. An example writer wrapper is an “any file writer” that writes data in any given format.

It may thus be appreciated that wrapper filters are useful in organizing graph intelligence into manageable blocks. Wrapper filters reduce development and maintenance time by simplifying graph architecture and by encouraging modular and object-oriented programming. Wrapper filters improve efficiency; an entire wrapper filter may be skipped when its work is obsolete.

Reference is made to APPENDIX B, which is a detailed object-oriented interface for implementing filters, in accordance with an embodiment of the present invention.

A concatenator transmits buffers from one filter to another. A concatenator represents the “glue” that attaches one filter to another. A concatenator ensures that a buffer that it retrieves for a filter, either from the buffer cache or from an input filter, is read locked. Each concatenator has a unique ID vis-à-vis a specific graph. A concatenator may inspect the buffer cache at any stage. However, since generally, inspecting buffer cache downgrades performance, the only concatenators that inspect the buffer cache are (i) concatenators with output forks, which query the buffer cache at a “fork” in the graph, and (ii) concatenators located before filters that may be skipped, and are tagged as “skippable” in APPENDIX B. A fork is a junction where more than two filters meet. There are input forks and output forks. An input fork is a junction when more than one filter enters, and one filter exits. An output fork is a junction where one filter enters and more than one filter exits.

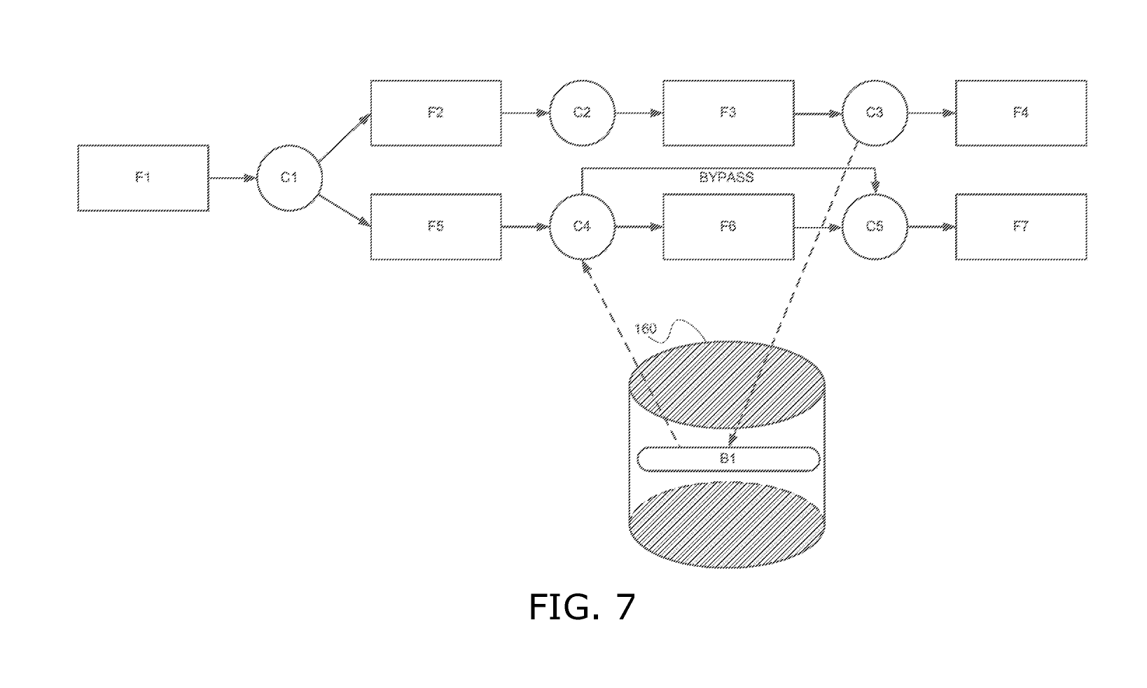

A concatenator may check the buffer cache, to determine if data processing may be bypassed, which is often useful at a fork. Reference is made to FIG. 7, which is a simplified drawing of a graph architecture with filters F1-F7 and concatenators C1-C5, in accordance with an embodiment of the present invention. Concatenator C1 is an output fork. In a typical workflow concatenator C3 may receive a buffer B1 (not shown) from filter F3, and store it in buffer cache 160. Subsequently, concatenator C4, determines that the output required from filter F6 is already stored in buffer cache 160 as B1. As such, concatenator bypasses processing though filter F6 and uses buffer B1 instead.

Reference is made to APPENDIX C, which is a detailed object-oriented interface for implementing concatenators, in accordance with an embodiment of the present invention.

A graph is a group of filters ordered in a specific manner to establish an overall processing task. The filters are connected via concatenators; each filter is linked to a concatenator which in turn may be linked to another filter. A graph encapsulates the filter-oriented nature of its components. By exposing methods such as “AddSegment”, “Start” and “Stop”, a user of a graph focuses on the graph target instead of the work of the filters. A graph may be operable, for example, to play a digital file on a display screen, to convert a bitmap image into a compressed JPEG image, or to analyze an audio stream to remove its noise. E.g., the following function is used to play a file.

void main( )
{
OutputEDLGraph player(1/*channel id*/);
player.AddSegment(“c:\\HeyJude.mp3”);
player.Start( );
getch( );
}

Graphs may be concatenated one to another. E.g., a graph that sends buffers to a sound card may be concatenated with a graph that mixes a stream from a number of tracks. The two graphs, when concatenated, operate in unison to mix tracks into a stream that is transmitted to the sound card.

A graph may be in various states, including (i) uninitialized, in which the graph resources have not yet been allocated, (ii) initialized, in which the graph resources are allocated, but have not yet been prepared, (iii) preparing, in which the graph's filter chains are being constructed, (iv) prepared, in which the graph may be used for transport control, start/stop/resume, (v) working, in which the graph is currently steaming data, (vi) paused, in which the graph is streaming silent audio or black frames of video, but does not release its allocated resources, (vii) stopping, in which the graph is in the process of stopping, (viii) stopped, in which the buffer streaming is finished and the graph will thereafter transition to prepared, and (ix) unpreparing, in which an up-prepare method was called and the graph will thereafter transition to uninitialized.

Reference is made to APPENDIX D, which is a detailed object-oriented interface for implementing graphs, in accordance with an embodiment of the present invention.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

### APPENDIX A: BUFFERS

The listing below provides definitions for class objects for IBufferData, Buffer and its different containers. These objects enable managing all types of auxiliary data. Buffer management is used to perform common actions on a buffer; e.g., duplicate a buffer, clear a buffer, split a buffer into two, trim the beginning/end of a buffer, concatenate a buffer to another buffer to create a larger buffer, and merge one buffer with another. When an action is performed on a buffer, all of the IBufferData is automatically updated accordingly. Notes appear after the listing.

| | |
|---|---|
| 1 | class IBufferHolder |
| 2 | { |

| | |
|---|---|
| 3 | public: |
| 4 | enum BufferHolderType |
| 5 | { |

| | |
|---|---|
| 6 | BHT_FILTER = 1, |
| 7 | BHT_CONCATENATOR = 2, |
| 8 | BHT_BUFFER = 3, |
| 9 | BHT_OTHER = 4 |

| | |
|---|---|
| 10 | }; |
| 11 | virtual ~IBufferHolder( ){ } |
| 12 | virtual Dtk::String GetName( ) const = 0; |
| 13 | virtual Dtk::String GetClassName( ) const = 0; |
| 14 | IBufferHolder* GetHolder( ) { return this;} |
| 15 | virtual BufferHolderType GetHolderType( ) const = 0; |
| 16 | virtual bool IsMultiThreaded( ) {return false;} |

| | |
|---|---|
| 17 | }; |
| 18 | class IBufferDataConst |
| 19 | { |
| 20 | public: |

| | |
|---|---|
| 21 | virtual ~IBufferDataConst( ) { } |
| 22 | virtual TimeCode::TCUnits GetBufferDataUnits( ) = 0; |
| 23 | virtual BufferDataType GetBufferDataType( ) = 0; |
| 24 | virtual Dtk::String GetBufferDataString( ) = 0; |
| 25 | virtual IBufferDataConst* GetConstImplementation( ) = 0; |
| 26 | virtual long GetMaxSize( ) = 0; |
| 27 | virtual bool IsEmpty( ) = 0; |
| 28 | virtual bool ValidateOffsets(TimeCode beginOffset, TimeCode |

endOffsets)= 0;

| | |
|---|---|
| 29 | virtual bool Duplicate(IBufferData *& destination, TimeCode |

beginOffset = TimeCode::zero_, TimeCode endOffset =
TimeCode::zero_) = 0;

| | |
|---|---|
| 30 | virtual bool CopyTo(TimeCode beginOffset, TimeCode endOffset, |

| | |
|---|---|
| | IBufferData* destination, TimeCode destinationBeginOffset) = 0; |
| 31 | }; |
| 32 | class IBufferData : public IBufferDataConst |
| 33 | { |
| 34 | public: |

| | | |
|---|---|---|
| 35 | virtual ~IBufferData( ) | { } |

| | |
|---|---|
| 36 | virtual bool Clean( ) = 0; |
| 37 | virtual bool Trim(TimeCode beginOffset, TimeCode endOffset) = |

0;

| | |
|---|---|
| 38 | virtual bool IsMergable(IBufferDataConst* otherBuffer) = 0; |
| 39 | virtual bool IsConcatable(IBufferDataConst* concatToMe, |

TimeCode beginOffset = TimeCode::zero_, TimeCode endOffset =
TimeCode::zero_) = 0;

| | |
|---|---|
| 40 | virtual bool Concat(IBufferDataConst* concatToMe, TimeCode |

beginOffset = TimeCode::zero_, TimeCode endOffset =
TimeCode::zero_) = 0;

| | |
|---|---|
| 41 | virtual bool Merge(IBufferDataConst* other) = 0; |
| 42 | virtual bool ShiftPosition(TimeCode positionOffset) = 0; |
| 43 | friend class Buffer; |

| | |
|---|---|
| 44 | }; |
| 45 | template<typename SampleT> |
| 46 | class GenericRawBuffer : public IBufferData |
| 47 | { |
| 48 | public: |

| | |
|---|---|
| 49 | GenericRawBuffer(TimeCode bufferMaxLength, |

| | |
|---|---|
| 50 | const VDDMFormat& audioFormat, |
| 51 | const TimeCode& bufferPosition |

| | |
|---|---|
| 52 | virtual ~GenericRawBuffer( ); |
| 53 | virtual BufferDataType GetBufferDataType( ); {return |

IRawBuffer::GetType( );}

| | |
|---|---|
| 54 | virtual Dtk::String GetBufferDataString( ) {return |

IRawBuffer::GetTypeString( );}

| | |
|---|---|
| 55 | virtual IBufferDataConst* GetConstImplementation( ); |
| 56 | virtual long GetMaxSize( ); |
| 57 | virtual TimeCode::TCUnits GetBufferDataUnits( ) { return |

TimeCode::TC_UNITS_BYTES; }

| | |
|---|---|
| 58 | virtual bool IsEmpty( ) {return (bufferLength_ == 0);} |
| 59 | virtual bool ValidateOffsets(TimeCode beginOffset, TimeCode |

endOffsets);

| | |
|---|---|
| 60 | virtual bool Duplicate(IBufferData *& destination, TimeCode |

beginOffset = TimeCode::zero_, TimeCode endOffset =
TimeCode::zero_);

| | |
|---|---|
| 61 | virtual bool CopyTo(TimeCode beginOffset, TimeCode endOffset, |

IBufferData* destination, TimeCode destinationBeginOffset) {
return false; }

| | |
|---|---|
| 62 | virtual bool Clean( ); |
| 63 | virtual bool Trim(TimeCode beginOffset, TimeCode endOffset); |
| 64 | virtual bool IsMergable(IBufferDataConst* otherBuffer); |
| 65 | virtual bool IsConcatable(IBufferDataConst* concatToMe, |

TimeCode beginOffset = TimeCode::zero_, TimeCode endOffset =
TimeCode::zero_);

| | |
|---|---|
| 66 | virtual bool Concat(IBufferDataConst* concatToMe, TimeCode |

beginOffset = TimeCode::zero_, TimeCode endOffset =
TimeCode::zero_);

| | |
|---|---|
| 67 | virtual bool Merge(IBufferDataConst* other); |
| 68 | virtual bool ShiftPosition(TimeCode positionOffset) { return |

true; }

| | |
|---|---|
| 69 | void* GetBuffer(bool changeBufferContent = true); |
| 70 | const void* GetReadOnlyBuffer( ) { return buffer_; } |
| 71 | TimeCode GetBufferMaxLength( ) { return |

REAL_TIMECODE_BYTES(bufferMaxLength_); }

| | |
|---|---|
| 72 | TimeCode GetBufferLength( ) { return |

REAL_TIMECODE_BYTES(bufferLength_); }

| | |
|---|---|
| 73 | void SetBufferLength(TimeCode bufferLength) { bufferLength_ = |

| | |
|---|---|
| | (long)(bufferLength.ToBytes( ) / SAMPLE_SIZE).GetValue( ); } |
| 74 | private: |

| | |
|---|---|
| 75 | SampleT* buffer_; |
| 76 | SampleType sampleType_; |
| 77 | long bufferMaxLength_; |
| 78 | const VDDMFormat& format_; |
| 79 | long bufferLength_; |
| 80 | const TimeCode& bufferPosition_; |

| | |
|---|---|
| 81 | }; |
| 82 | class LocatorsBuffer : public IBufferData |
| 83 | { |
| 84 | public: |

| | |
|---|---|
| 85 | LocatorsBuffer(const VDDMFormat& audioFormat, TimeCode |

bufferMaxLength);

| | |
|---|---|
| 86 | virtual ~LocatorsBuffer( ); |
| 87 | virtual Dtk::String GetBufferDataString( ) { return |

(“LocatorsBuffer”);}

| | |
|---|---|
| 88 | virtual BufferDataType GetBufferDataType( ) { return |

BD_MPEG_LOCATORS; }

| | |
|---|---|
| 89 | virtual IBufferDataConst* GetConstImplementation( ); |
| 90 | virtual TimeCode::TCUnits GetBufferDataUnits( ) {return |

bufferUnits_;}

| | |
|---|---|
| 91 | virtual long GetMaxSize( ); |
| 92 | virtual bool IsEmpty( ) { return locators_.empty( ); } |
| 93 | virtual bool Clean( ); |
| 94 | virtual bool ValidateOffsets(TimeCode beginOffset, TimeCode |

endOffsets);

| | |
|---|---|
| 95 | virtual bool Trim(TimeCode beginOffset, TimeCode endOffset); |
| 96 | virtual bool IsConcatable(IBufferDataConst* concatToMe, |

TimeCode beginOffset = TimeCode::zero_, TimeCode endOffset =
TimeCode::zero_);

| | |
|---|---|
| 97 | virtual bool Concat(IBufferDataConst* concatToMe, TimeCode |

beginOffset = TimeCode::zero_, TimeCode endOffset =
TimeCode::zero_);

| | |
|---|---|
| 98 | virtual bool Duplicate(IBufferData*& destination, TimeCode |

beginOffset = TimeCode::zero_, TimeCode endOffset =
TimeCode::zero_);

| | |
|---|---|
| 99 | virtual bool IsMergable(IBufferDataConst* otherBuffer); |
| 100 | virtual bool Merge(IBufferDataConst* other) { return false; } |
| 101 | virtual bool CanCopyTo(TimeCode beginOffset, TimeCode |

endOffset, IBufferData* destination, TimeCode
destinationBeginOffset) { return false; }

| | |
|---|---|
| 102 | virtual bool CopyTo(TimeCode beginOffset, TimeCode endOffset, |

IBufferData* destination, TimeCode destinationBeginOffset) {
return false; }

| | |
|---|---|
| 103 | virtual bool ShiftPosition(TimeCode positionOffset); |
| 104 | bool AddLocator( |

| | |
|---|---|
| 105 | const VDDMLocator& locator, |
| 106 | bool validateSamplePosition = true); |

| | |
|---|---|
| 107 | Dtk::String toString( ); |
| 108 | const VDDMLocator::LOCATORS& GetLocators ( ); |

| | |
|---|---|
| 109 | private: |

| | |
|---|---|
| 110 | VDDMLocator::LOCATORS locators_; |

| | |
|---|---|
| 111 | }; |
| 112 | class FreqBufferData : public IBufferData |
| 113 | { |
| 114 | public: |

| | |
|---|---|
| 115 | FreqBufferData(TimeCode bufferMaxLength, const VDDMFormat& |

format);

| | |
|---|---|
| 116 | virtual ~FreqBufferData( ); |
| 117 | virtual BufferDataType GetBufferDataType( ) { return |

BD_FREQ_DATA; }

| | |
|---|---|
| 118 | virtual Dtk::String GetBufferDataString( ) { return |

GetStringType( ); }

| | |
|---|---|
| 119 | virtual IBufferDataConst* GetConstImplementation( ); |
| 120 | virtual TimeCode::TCUnits GetBufferDataUnits( ) { return |

bufferUnits_; };

| | |
|---|---|
| 121 | virtual long GetMaxSize( ); |
| 122 | virtual bool IsEmpty( ); |
| 123 | virtual bool Clean( ); |
| 124 | virtual bool ValidateOffsets(TimeCode beginOffset, TimeCode |

endOffset);

| | |
|---|---|
| 125 | virtual bool Trim(TimeCode beginOffset, TimeCode endOffset) { |

return IsEmpty( ); }

| | |
|---|---|
| 126 | virtual bool IsConcatable(IBufferDataConst* concatToMe, |

TimeCode beginOffset = TimeCode::zero_, TimeCode endOffset =
TimeCode::zero_) { return IsEmpty( ); }

| | |
|---|---|
| 127 | virtual bool Concat(IBufferDataConst* concatToMe, TimeCode |

beginOffset = TimeCode::zero_, TimeCode endOffset =
TimeCode::zero_) { return IsEmpty( ); }

| | |
|---|---|
| 128 | virtual bool Duplicate(IBufferData*& destination, TimeCode |

beginOffset = TimeCode::zero_, TimeCode endOffset =
TimeCode::zero_);

| | |
|---|---|
| 129 | virtual bool IsMergable(IBufferDataConst* otherBuffer) { return |

IsEmpty( ); }

| | |
|---|---|
| 130 | virtual bool Merge(IBufferDataConst* other) { return IsEmpty( ); |

}

| | |
|---|---|
| 131 | virtual bool CanCopyTo(TimeCode beginOffset, TimeCode |

endOffset, IBufferData* destination, TimeCode
destinationBeginOffset) { return IsEmpty( ); }

| | |
|---|---|
| 132 | virtual bool CopyTo(TimeCode beginOffset, TimeCode endOffset, |

IBufferData* destination, TimeCode destinationBeginOffset) {
return IsEmpty( ); }

| | |
|---|---|
| 133 | virtual bool ShiftPosition(TimeCode positionOffset) {return |

IsEmpty( );}

| | |
|---|---|
| 134 | DftType* GetRealBuffer( ); |
| 135 | DftType* GetImagainaryBuffer( ); |
| 136 | enum DFT_METHOD |
| 137 | { |

| | |
|---|---|
| 138 | TRIGONOMETRIC_CORRELATION, |
| 139 | COMPLEX_CORRELATION, |
| 140 | FAST_FOURIER_TRANSFORM |

| | |
|---|---|
| 141 | }; |
| 142 | bool ForwardDft(const DftType* temporalData, DFT_METHOD |

dftMethod = TRIGONOMETRIC_CORRELATION);

| | |
|---|---|
| 143 | bool InverseDft( DftType* temporalData, DFT_METHOD dftMethod = |

| | |
|---|---|
| | TRIGONOMETRIC_CORRELATION); |
| 144 | }; |
| 145 | class VolDataBuffer : public IBufferData |
| 146 | { |
| 147 | public: |

| | |
|---|---|
| 148 | VolDataBuffer(const VDDMFormat& audioFormat, |

| | |
|---|---|
| 149 | TimeCode rawBufferMaxLength); |

| | |
|---|---|
| 150 | virtual ~VolDataBuffer( ); |
| 151 | virtual BufferDataType GetBufferDataType( ) { return |

BD_VOL_DATA; }

| | |
|---|---|
| 152 | virtual Dtk::String GetBufferDataString( ) { return |

(“VolDataBuffer”); }

| | |
|---|---|
| 153 | virtual long GetMaxSize( ); |
| 154 | virtual bool IsEmpty( ) { return (bufferLength_ == 0); } |
| 155 | virtual bool Clean( ); |
| 156 | virtual bool ValidateOffsets(TimeCode beginOffset, TimeCode |

endOffsets);

| | |
|---|---|
| 157 | virtual bool Trim(TimeCode beginOffset, TimeCode endOffset); |
| 158 | virtual bool IsConcatable(IBufferDataConst* concatToMe, |

TimeCode beginOffset = TimeCode::zero_, TimeCode endOffset =
TimeCode::zero_);

| | |
|---|---|
| 159 | virtual bool Concat(IBufferDataConst* concatToMe, TimeCode |

beginOffset = TimeCode::zero_, TimeCode endOffset =
TimeCode::zero_);

| | |
|---|---|
| 160 | virtual bool Duplicate(IBufferData*& destination, TimeCode |

beginOffset = TimeCode::zero_, TimeCode endOffset =
TimeCode::zero_);

| | |
|---|---|
| 161 | virtual bool IsMergable(IBufferDataConst* otherBuffer); |
| 162 | virtual bool Merge(IBufferDataConst* other) { return false;} |
| 163 | virtual bool CopyTo(TimeCode beginOffset, TimeCode endOffset, |

IBufferData* destination, TimeCode destinationBeginOffset);

| | |
|---|---|
| 164 | virtual bool ShiftPosition(TimeCode positionOffset) { return |

true; }

| | |
|---|---|
| 165 | enum VolDataType |
| 166 | { |

| | |
|---|---|
| 167 | PEAK = 1, |
| 168 | PPM = 2, |
| 169 | RMS = 3 |

| | |
|---|---|
| 170 | }; |
| 171 | VolDataType GetVolDataType( ) { return volType_; } |
| 172 | void SetVolDataType(VolDataType volDataType) { volType_ = |

volDataType; }

| | |
|---|---|
| 173 | WORD* GetBuffer( ); |

| | |
|---|---|
| 174 | private: |

| | |
|---|---|
| 175 | WORD *volEnergy_; |

| | |
|---|---|
| 176 | }; |
| 177 | class ProcessingDataBuffer : public IBufferData |
| 178 | { |
| 179 | public: |

| | |
|---|---|
| 180 | ProcessingDataBuffer( ); |
| 181 | virtual ~ProcessingDataBuffer( ); |
| 182 | virtual BufferDataType GetBufferDataType( ) { return |

BD_PROCESSING_DATA; }

| | |
|---|---|
| 183 | virtual Dtk::TString GetBufferDataString( ) { return |

_T(“ProcessingDataBuffer”);}

| | |
|---|---|
| 184 | virtual _{——}int64 GetMaxSize( ); |
| 185 | virtual bool IsEmpty( ) { return (processingData_ == 0); } |
| 186 | virtual bool Clean( ); |

187

| | |
|---|---|
| 188 | virtual bool ValidateOffsets(TimeCode beginOffset, TimeCode |

endOffsets) { return true; }

| | |
|---|---|
| 189 | virtual bool Trim(TimeCode beginOffset, TimeCode endOffset) { |

return true; }

| | |
|---|---|
| 190 | virtual bool IsConcatable(IBufferDataConst* concatToMe, |

TimeCode beginOffset = 0, TimeCode endOffset = 0);

| | |
|---|---|
| 191 | virtual bool Concat(IBufferDataConst* concatToMe, TimeCode |

beginOffset = 0, TimeCode endOffset = 0) { return true;}

| | |
|---|---|
| 192 | virtual bool Duplicate(IBufferData*& destination, TimeCode |

beginOffset = 0, TimeCode endOffset = 0);

| | |
|---|---|
| 193 | virtual bool IsMergable(IBufferDataConst* otherBuffer); |
| 194 | virtual bool Merge(IBufferDataConst* other) { return false; } |
| 195 | virtual bool CopyTo(TimeCode beginOffset, TimeCode endOffset, |

IBufferData* destination, _{——}int64 destinationBeginOffset) { return
Duplicate(destination); }

| | |
|---|---|
| 196 | virtual bool ShiftPosition(_{——}int64 positionOffset) {return |

true;}

| | |
|---|---|
| 197 | const QWORD GetProcessingData( ) { return processingData_; } |
| 198 | bool AddProcessor(QWORD processorFlag); |
| 199 | bool IsProcessedBy(QWORD filterId) {return (processingData_ & |

| | |
|---|---|
| | filterId);} |
| 200 | private: |

| | |
|---|---|
| 201 | QWORD processingData_; |

| | |
|---|---|
| 202 | }; |
| 203 | class Buffer : public BufferHolder |
| 204 | { |
| 205 | public: |

| | |
|---|---|
| 206 | Buffer( const TimeCode& bufferSizeInBytes |

| | |
|---|---|
| 207 | const VDDMFormat& audioFormat, |
| 208 | IAllocator* allocator, |
| 209 | ResourcesOrderMonitor * rom = NULL, |
| 210 | IRawBuffer::SampleType sampleType = |

IRawBuffer::ST_VDDM_DEFAULT);

| | |
|---|---|
| 211 | virtual ~Buffer( ); |
| 212 | int GetBufferId( ) const { return bufferId_; } |
| 213 | const VDDMFormat& GetVDDMFormat( ) const {return format_;} |
| 214 | TimeCode GetBufferMaxLength( ) const { return |

bufferMaxLengthInBytes_; }

| | |
|---|---|
| 215 | void SetBufferPosition(const TimeCode& bufferPosition) { |

bufferPosition_ = bufferPosition; }

| | |
|---|---|
| 216 | TimeCode GetBufferPosition( ) const { return bufferPosition_; } |
| 217 | TimeCode GetBufferLength( ) const { return bufferLength_; } |
| 218 | void SetBufferLength(const TimeCode& bufferLength); |
| 219 | TimeCode GetBufferEndPosition( ) const {return bufferPosition_ + |

bufferLength_;}

| | |
|---|---|
| 220 | IBufferData* GetIBufferData(const BufferDataType& bufferType, |

IBufferHolder *holder);

| | |
|---|---|
| 221 | IBufferDataConst* GetIBufferDataConst(const BufferDataType& |

bufferType, IBufferHolder *holder);

| | |
|---|---|
| 222 | long GetMaxSize( ); |
| 223 | bool IsEmpty( ); |
| 224 | bool Clean( ); |
| 225 | bool ValidateOffsets(const TimeCode& beginOffset, const |

TimeCode& endOffsets);

| | |
|---|---|
| 226 | bool Trim(const TimeCode& beginOffset, const TimeCode& |

endOffset);

| | |
|---|---|
| 227 | bool IsConcatable(Buffer* concatToMe, const TimeCode& |

beginOffset = TimeCode::zero_, const TimeCode& endOffset =
TimeCode::zero_, bool showError = true, BufferDataType*
bufferDataTypeFailed= NULL);

| | |
|---|---|
| 228 | bool Concat(Buffer* concatToMe, const TimeCode& beginOffset = |

TimeCode::zero_, const TimeCode& endOffset = TimeCode::zero_);

| | |
|---|---|
| 229 | bool LockWrite(IBufferHolder* holder, bool expectingFailure = |

false);

| | |
|---|---|
| 230 | bool LockRead(IBufferHolder* holder, bool expectingFailure = |

false);

| | |
|---|---|
| 231 | bool Free(IBufferHolder* holder); |

| | |
|---|---|
| 232 | private: |

| | |
|---|---|
| 233 | int bufferId_; |
| 234 | VDDMFormat format_;//the buffer's data format |
| 235 | TimeCode bufferMaxLengthInBytes_; |
| 236 | TimeCode bufferLength_; |
| 237 | typedef vector< IBufferData*> BufferDataContainer; |
| 238 | BufferDataContainer data_; |

| | |
|---|---|
| 239 | }; |
| 240 | class BufferList : public AllocationUnitList |
| 241 | { |
| 242 | public: |

| | |
|---|---|
| 243 | BufferList(const TimeCode& bufferSize, |

| | |
|---|---|
| 244 | const VDDMFormat& format, |
| 245 | DWORD maxRamToUseCritical, |
| 246 | ResourcesOrderMonitor* rom = NULL, |
| 247 | IRawBuffer::SampleType defaultSampleType = |

IRawBuffer::ST_VDDM_DEFAULT,

| | |
|---|---|
| 248 | int initialBufferAllocationSize = 0, |
| 249 | int growingBufferAllocationSize = 0, |
| 250 | int percentageOfBufferListToFreeWhenAllocatingBuffer = 0); |

| | |
|---|---|
| 251 | virtual ~BufferList( ); |
| 252 | inline TimeCode GetBufferSize( ) { return bufferLength_; } |
| 253 | inline const VDDMFormat& GetVDDMFormat( ) { return format_; } |
| 254 | inline int HowManyBuffersInList( ) { return |

HowManyUnitsInList( ); }

| | |
|---|---|
| 255 | inline int HowManyUsedBuffers( ) { return numberOfUsedUnits_; } |
| 256 | Buffer* GetFreeBuffer(IBufferHolder* holder, |

IRawBuffer::SampleType sampleType = IRawBuffer::ST_VDDM_DEFAULT);

| | |
|---|---|
| 257 | long GetBufferMaxSize( ) { return unitSize_;} |

| | |
|---|---|
| 258 | private: |

| | |
|---|---|
| 259 | const VDDMFormat format_; |
| 260 | const TimeCode bufferLength_; |
| 261 | list<Buffer*> buffers_; |

| | |
|---|---|
| 262 | }; |
| 263 | class BufferPool |
| 264 | { |
| 265 | public: |

| | |
|---|---|
| 266 | BufferPool(Dtk::String module, |

| | |
|---|---|
| 267 | ResourcesOrderMonitor* rom = NULL, |
| 268 | BufferPoolConfiguration configuration = |

BufferPoolConfiguration( ));

| | |
|---|---|
| 269 | virtual ~BufferPool( ); |
| 270 | Buffer* GetFreeBuffer(const TimeCode& bufferSize, |

| | |
|---|---|
| 271 | const VDDMFormat& audioFormat, |
| 272 | IBufferHolder *holder, |
| 273 | IRawBuffer::SampleType sampleType = |

| | |
|---|---|
| | IRawBuffer::ST_VDDM_DEFAULT); |
| 274 | private: |

| | |
|---|---|
| 275 | BufferList* CreateBufferList( |

| | |
|---|---|
| 276 | TimeCode bufferSize, |
| 277 | const VDDMFormat& audioFormat, |
| 278 | IRawBuffer::SampleType sampleType, |
| 279 | IBufferHolder *holder); |

| | |
|---|---|
| 280 | map<BufferListKey, BufferList*> bufferLists_; |

| | |
|---|---|
| 281 | }; |
| 282 | class BufferCache : public BufferHolder |
| 283 | { |
| 284 | public: |

| | |
|---|---|
| 285 | class BufferCacheKey |
| 286 | { |
| 287 | public: |

| | |
|---|---|
| 288 | BufferCacheKey(TimeCode bufferPosition, VDDMFormat |

audioFormat, QWORD processingData);

| | |
|---|---|
| 289 | virtual ~BufferCacheKey( ); |
| 290 | BufferCacheKey& operator=(const BufferCacheKey& key); |
| 291 | bool operator==(const BufferCacheKey& key); |
| 292 | bool operator!=(const BufferCacheKey& key); |

| | |
|---|---|
| 293 | private: |

| | |
|---|---|
| 294 | QWORD processingData_; |
| 295 | DDMFormat format_; |
| 296 | TimeCode bufferPosition_; |

| | |
|---|---|
| 297 | }; |
| 298 | BufferCache( ); |
| 299 | virtual ~BufferCache( ); |
| 300 | bool AddBuffer(Buffer* buffer); |
| 301 | Buffer* GetBuffer(BufferCacheKey key); |

| | |
|---|---|
| 302 | private: |

| | |
|---|---|
| 303 | map<BufferCacheKey,Buffer*> cache_; |

| | |
|---|---|
| 304 | }; |

Lines 1-17: These lines define an object of type IBufferHolder, which may register itself as a Buffer user The IBufferHolder is used to follow the buffer ownership transitions.
Lines 18-44: These lines define objects of type IBufferDataConst and IBufferData. These objects contain the raw and auxiliary buffer data, for read-only and write accesses, respectively. The methods of those objects manage a standard serial memory workflow, including inter alia clean, trim and concatenate. Buffer data is used by filters to store and retrieve auxiliary data, to avoid re-analyzing buffer raw data if the analysis was already performed.
Lines 45-202: These lines define a few samples for objects that implement IBufferData—the raw and auxiliary data.
Lines 45-81: These lines define the buffer data that contains the raw data as a byte stream.
Lines 82-111: These lines define the buffer data that contains a list of locators to mark variety of positions on the buffer's content.
Lines 112-144: These lines define the buffer data that contains Frequency-domain data of the buffer, i.e., Fast Fourier Transform results.
Lines 145-176: These lines define the buffer data that contains the buffer's energy summary, with variety of energy-summing methods including inter alia PPM and RMS.
Lines 177-202: These lines define the buffer data that contains the ProcessingData of a Buffer, which is an object that records which filters have already processed the Buffer. Each filter has a unique bitwise value; namely, its filterProcessId. This buffer data records previous processing filters by bitwise the filterProcessId of the filters processed the buffer.
Lines 203-240: These lines define the Buffer object which encapsulates a buffer data list, i.e., the raw and auxiliary data.
Lines 203-219: These lines define methods that have fixed content irrespective of the buffer data lists.
Lines 220-228: Those lines access a buffer data list, and allow join memory operations, such as trim and merge, applicable to all the buffer data in unison.
Lines 229-231: These lines provide the ownership control of a buffer-locked for read/write access or free of owners.
Lines 232-239: These lines define a buffer's members, including inter alia the buffer-data list.
Lines 240-262: These lines define a BufferList; namely, an object that encapsulates a list of buffers of a certain format and length, and provides free buffers on demand.
Lines 263-281: These lines describe the buffer pool, which manages the memory of the graph by managing the buffer lists.
Lines 282-304: These lines describe the buffer cache, where buffers are sorted using a BufferCacheKey; i.e., by their position, format and processing data. The buffer cache is used by a concatenator to store and retrieve processed buffers, in order to avoid repeated processing of the same data.

### APPENDIX B: FILTERS

The listing below provides definitions for class objects for a IFilter and its derivatives. Notes appear after the listing.

| | |
|---|---|
| 305 | class IFilter : public IBufferHolder |
| 306 | { |
| 307 | public: |

| | | |
|---|---|---|
| 308 | virtual ~IFilter( ) | {} |

| | | |
|---|---|---|
| 309 | virtual bool | Prepare( ) = 0; |
| 310 | virtual bool | Unprepare( ) = 0; |

| | |
|---|---|
| 311 | virtual Dtk::TString GetLastError( ) = 0; |
| 312 | virtual VDDMFactory* GetVDDMFactory( ) = 0; |
| 313 | virtual int LogMe( ) = 0; |
| 314 | virtual UINT GetFilterUniqueId( ) = 0; |
| 315 | virtual NodeType GetNodeType( ) const = 0;. |
| 316 | QWORD GetFilterProcessId ( ) const {return 0;} |
| 317 | virtual TimeCode::TCUnits GetFilterUnits( ) = 0; |

| | |
|---|---|
| 318 | protected: |

| 319 | virtual bool Process( ) = 0; | |
|---|---|---|
| 320 | virtual bool | ShouldAbort( ) = 0; |

| | |
|---|---|
| 321 | }; |
| 322 | class IReaderFilter : public virtual IFilter |
| 323 | { |
| 324 | public: |

| | |
|---|---|
| 325 | virtual ~IReaderFilter( ) { } |
| 326 | virtual ReadStatus ReadNextBuffer(Buffer*& buffer) = 0; |
| 327 | virtual bool IsEndOfOutput( ) = 0; |
| 328 | virtual TimeCode GetOutPosition( ) = 0; |
| 329 | virtual PositionStatus SetPosition (const TimeCode& position, |

bool forceRefresh = false) = 0;

| | |
|---|---|
| 330 | virtual VDDM::TimeCode GetBlockAlignment( ) = 0; |
| 331 | virtual void SetReaderErrorState( ) { } |

| | |
|---|---|
| 332 | }; |
| 333 | class IWriterFilter : public virtual IFilter |
| 334 | { |
| 335 | public: |

| | |
|---|---|
| 336 | virtual ~IWriterFilter( ) { } |
| 337 | virtual bool WriteNextBuffers(list<Buffer*> buffers) = 0; |
| 338 | virtual TimeCode GetInPosition( ) = 0; |
| 339 | virtual void SetEndOfInput(bool isEndOfInput) = 0; |
| 340 | virtual void FlushPosition( ) = 0; |
| 341 | virtual void SetWriterErrorState( ) { } |

| | |
|---|---|
| 342 | }; |
| 343 | class IMiddleFilter : public IReaderFilter, public IWriterFilter |
| 344 | { |
| 345 | public: |

| | |
|---|---|
| 346 | virtual ~IMiddleFilter( ) { } |
| 347 | virtual VDDMFormat GetOutputFormat(const VDDMFormat& |

inputFormat) = 0;

| | |
|---|---|
| 348 | virtual VDDMFormat GetInputFormat(const VDDMFormat& |

outputFormat) = 0;

| | |
|---|---|
| 349 | virtual bool IsSkippable( ) = 0; |
| 350 | virtual bool CanSkipBuffer(Buffer* outputBuffer) = 0; |
| 351 | virtual void SkipBuffer(Buffer* outputBuffer) = 0; |
| 352 | virtual bool IsTrivial( ) = 0; |
| 353 | virtual bool HasProcessingWorkOnBuffer(Buffer*& inputBuffer, |

IBufferHolder* currentHolder) = 0;

| | |
|---|---|
| 354 | virtual void Flush( ) = 0; |
| 355 | virtual void SetErrorState( ) { } |

| | |
|---|---|
| 356 | }; |
| 357 | class ReaderFilterBase : public IReaderFilter |
| 358 | { |
| 359 | public: |

| | |
|---|---|
| 360 | ReaderFilterBase(const Dtk::String& name, |

| 361 | | const Dtk::String& className, |
|---|---|---|
| 362 | | VDDMFactory* ddmFactory, |
| 363 | | const VDDMFormat& outputFormat = |
| | VDDMFormat::GetEmptyFormat( ), | |
| 364 | | const Dtk::String& moduleName = (“”), |
| 365 | | NodeType nodeType = NT_FILTER); |

| | |
|---|---|
| 366 | virtual ~ReaderFilterBase( ); |
| 367 | virtual ReadStatus ReadNextBuffer(Buffer*& buffer); |
| 368 | virtual bool IsEndOfOutput( ) { return isEndOfOutput_;} |
| 369 | virtual TimeCode GetOutPosition( ) { return outPosition_;} |
| 370 | virtual PositionStatus SetPosition (const TimeCode& position, |

bool forceRefresh = false);

| | |
|---|---|
| 371 | virtual VDDM::TimeCode GetBlockAlignment( ) { return |

blockAlignment_;}

| | |
|---|---|
| 372 | virtual Dtk::String GetClassName( ) const {return |

filterClassName_;}

| | |
|---|---|
| 373 | virtual Dtk::String GetName( ) const { return filterName_;} |
| 374 | virtual IBufferHolder::BufferHolderType GetHolderType( ) const { |

return IBufferHolder::BHT_FILTER; }

| | |
|---|---|
| 375 | virtual NodeType GetNodeType( ) const {return nodeType_;} |
| 376 | virtual Dtk::TString GetLastError( ); |

| | |
|---|---|
| 377 | protected: |

| | |
|---|---|
| 378 | list<Buffer*> outputBuffers_{—} |
| 379 | TimeCode outPosition_{—} |

| | |
|---|---|
| 380 | }; |
| 381 | class WriterFilterBase : public IWriterFilter |
| 382 | { |
| 383 | public: |

| | |
|---|---|
| 384 | WriterFilterBase(const Dtk::String& name, |

| | |
|---|---|
| 385 | const Dtk::String& className, |
| 386 | VDDMFactory* ddmFactory, |
| 387 | const Dtk::String& moduleName = (“”), |
| 388 | NodeType nodeType = NT_FILTER); |

| | |
|---|---|
| 389 | virtual ~WriterFilterBase( ); |
| 390 | virtual bool WriteNextBuffers(list<Buffer*> buffers); |
| 391 | virtual TimeCode GetInPosition( ) { return inPosition_;} |
| 392 | virtual void SetEndOfInput(bool isEndOfInput) { isEndOfInput_ = |

isEndOfInput;}

| | |
|---|---|
| 393 | virtual Dtk::String GetName( ) const { return filterName_;} |
| 394 | virtual IBufferHolder::BufferHolderType GetHolderType( ) const { |

return IBufferHolder::BHT_FILTER; }

| | |
|---|---|
| 395 | virtual Dtk::TString GetLastError( ); |
| 396 | virtual VDDMFactory* GetVDDMFactory( ) { return ddmFactory_; } |
| 397 | virtual int LogMe( ) { return logMe_; } |
| 398 | virtual UINT GetFilterUniqueId( ) { return filterUniqueId_; } |
| 399 | virtual Dtk::String GetClassName( ) const {return |

filterClassName_;}

| | |
|---|---|
| 400 | virtual void FlushPosition( ); |

| | |
|---|---|
| 401 | protected: |

| | |
|---|---|
| 402 | list<Buffer*> inputBuffers_; |
| 403 | TimeCode inPosition_; |

| | |
|---|---|
| 404 | }; |
| 405 | class MiddleFilterBase : public IMiddleFilter |
| 406 | { |
| 407 | public: |

| | |
|---|---|
| 408 | MiddleFilterBase(const Dtk::String& name, |

| | |
|---|---|
| 409 | const Dtk::String& className, |
| 410 | bool overrideSetPosition, |
| 411 | VDDMFactory* ddmFactory, |
| 412 | const Dtk::String& moduleName = (“”), |
| 413 | NodeType nodeType = NT_FILTER); |

| | |
|---|---|
| 414 | virtual ~MiddleFilterBase( ); |
| 415 | virtual ReadStatus ReadNextBuffer(Buffer*& buffer); |
| 416 | virtual bool WriteNextBuffers(list<Buffer*> buffers); |
| 417 | virtual TimeCode GetInPosition( ) { return inPosition_; } |
| 418 | virtual void SetEndOfInput(bool isEndOfInput); |
| 419 | virtual bool IsEndOfOutput( ) {return isEndOfOutput_;} |
| 420 | virtual TimeCode GetOutPosition( ) { return outPosition_;} |
| 421 | virtual PositionStatus SetPosition (const TimeCode& position, |

bool forceRefresh = false);

| | |
|---|---|
| 422 | virtual VDDMFormat GetOutputFormat(const VDDMFormat& |

inputFormat) { return inputFormat;}

| | |
|---|---|
| 423 | virtual VDDMFormat GetInputFormat(const VDDMFormat& |

outputFormat) { return outputFormat;}

| | |
|---|---|
| 424 | virtual bool CanSkipBuffer(Buffer* outputBuffer); |
| 425 | virtual void SkipBuffer(Buffer* outputBuffer); |
| 426 | virtual void Flush( ); |

| | |
|---|---|
| 427 | protected: |

| | |
|---|---|
| 428 | BufferPool* bufferPool_; |
| 429 | list<Buffer*> inputBuffers_, intermidiateBuffers_, |

outputBuffers_;

| | |
|---|---|
| 430 | TimeCode inPosition_, outPosition_; |

| | |
|---|---|
| 431 | }; |
| 432 | class WrapperFilterBase : public MiddleFilterBase |
| 433 | { |
| 434 | public: |

| | |
|---|---|
| 435 | WrapperFilterBase(const Dtk::String& name, |

| | |
|---|---|
| 436 | const Dtk::String& className, |
| 437 | VDDMFactory* ddmFactory, |
| 438 | NodeType nodeType, |
| 439 | const Dtk::String& moduleName = (“”)); |

| | |
|---|---|
| 440 | virtual ~WrapperFilterBase( ); |
| 441 | virtual bool Unprepare( ); |
| 442 | virtual PositionStatus SetPosition(const TimeCode& position, |

bool forceRefresh = false);

| | |
|---|---|
| 443 | virtual void SetEndOfInput(bool isEndOfInput); |
| 444 | virtual bool CanSkipBuffer(Buffer* outputBuffer) { return |

false; }

| | |
|---|---|
| 445 | virtual void SkipBuffer(Buffer* outputBuffer) { } |
| 446 | virtual bool IsSkippable( ) { return false; } |

| | |
|---|---|
| 447 | protected: |

| | |
|---|---|
| 448 | list<IFilter*> filters_; |
| 449 | list<Concatenator *> concatenators_; |

| | |
|---|---|
| 450 | }; |
| 451 | class ReaderWrapper : public WrapperFilterBase |
| 452 | { |
| 453 | public: |

| | |
|---|---|
| 454 | ReaderWrapper(const Dtk::String& name, |

| | |
|---|---|
| 455 | const Dtk::String& className, |
| 456 | VDDMFactory* ddmFactory, |
| 457 | const Dtk::String& moduleName = (“”)); |

| | |
|---|---|
| 458 | virtual ~ReaderWrapper( ); |
| 459 | virtual ReadStatus ReadNextBuffer(Buffer*& buffer); |
| 460 | virtual bool IsTrivial( ) { return false; } |

| | |
|---|---|
| 461 | protected: |

| | | |
|---|---|---|
| 462 | virtual bool | Process( ); |

| | |
|---|---|
| 463 | }; |
| 464 | class WriterWrapper : public WrapperFilterBase |
| 465 | { |
| 466 | public: |

| | |
|---|---|
| 467 | WriterWrapper(const Dtk::String& name, |

| | |
|---|---|
| 468 | const Dtk::String& className, |
| 469 | VDDMFactory* ddmFactory, |
| 470 | const Dtk::String& moduleName = (“”)); |

| 471 | virtual ~WriterWrapper( ); | |
|---|---|---|
| 472 | virtual bool | Unprepare( ); |
| 473 | virtual bool | WriteNextBuffers(list<Buffer*> buffers); |
| 474 | virtual void | SetEndOfInput(bool isEndOfInput); |
| 475 | virtual bool | IsTrivial( ) {return false;} |

| | |
|---|---|
| 476 | protected: |

| | | |
|---|---|---|
| 477 | virtual bool | Process( ); |

| | |
|---|---|
| 478 | }; |
| 479 | class MiddleWrapper : public WrapperFilterBase |
| 480 | { |
| 481 | public: |

| | |
|---|---|
| 482 | MiddleWrapper(const Dtk::String& name, |

| | |
|---|---|
| 483 | const Dtk::String& className, |
| 484 | VDDMFactory* ddmFactory, |
| 485 | const Dtk::String& moduleName = (“”)); |

| | |
|---|---|
| 486 | virtual ~MiddleWrapper( ); |
| 487 | virtual bool WriteNextBuffers(list<Buffer*> buffers); |
| 488 | virtual void SetEndOfInput(bool isEndOfInput); |
| 489 | virtual bool IsTrivial( ); |
| 490 | virtual bool CanSkipBuffer(Buffer* outputBuffer); |
| 491 | virtual void SkipBuffer(Buffer* outputBuffer); |

| | |
|---|---|
| 492 | protected: |

| | |
|---|---|
| 493 | virtual bool Process( ); |

| | |
|---|---|
| 494 | }; |

Lines 305-321: These lines define the IFilter class corresponding to a generic filter.
Lines 322-332: These lines define the IReaderFilter class, which reads a next buffer from a filter's source.
Lines 333-341: These lines define the IWriterFilter class, which writes a next output buffer to a graph target; namely, file, memory or other device.
Lines 342-356: These lines define the IMiddleFilter class, which perform administrative or processing tasks on a buffer.
Lines 357-380: These lines define the ReaderFilterBase class, which implements common IReaderFilter tasks.
Lines 381-404: These lines define the WriteFilterBase class, which implement common IWriterFilter tasks.
Lines 405-431: These lines define the MiddleFilerBase class, which implement common IMiddleFilter tasks.
Lines 432-450: These lines define the wrapperFilterBase class, which encapsulates a sequence of filters to form a sub-graph of particular task.
Lines 451-463: These lines define the ReaderWrapper class, a sub-graph for reading.
Lines 464-478: These lines define the writerwrapper class, a sub-graph for writing.
Lines 489-494: These lines define the MiddleWrapper class, a sub-graph for processing the buffer's content.

### APPENDIX C: CONCATENATORS

The listing below provides definitions for class objects for a concatenator. Notes appear after the listing.

| | |
|---|---|
| 495 | class Concatenator : public BufferHolder |
| 496 | { |
| 497 | public: |

| | |
|---|---|
| 498 | Concatenator (VDDMFactory* ddmFactory, bool |

removeFiltersOnError = false);

| | |
|---|---|
| 499 | virtual ~Concatenator ( ); |
| 500 | UINT GetId( ) { return concatenatorId_; } |
| 501 | bool WriteNextBuffer(bool& isEndPosition, bool sleepOnError = |

false, ReadStatus * lastReadStatus = NULL);

| | |
|---|---|
| 502 | static bool Concat(IReaderFilter* filter, Concatenator * |

concatenator );

| | |
|---|---|
| 503 | static bool Concat(Concatenator * prevConcatenator, |

IMiddleFilter* filter, Concatenator * concatenator );

| | |
|---|---|
| 504 | static bool Concat(Concatenator * concatenator , IWriterFilter* |

filter);

| | |
|---|---|
| 505 | static bool Remove(IReaderFilter* filter, Concatenator * |

concatenator );

| | |
|---|---|
| 506 | static bool Remove(Concatenator * prevConcatenator, |

IMiddleFilter* filter, Concatenator * concatenator );

| | |
|---|---|
| 507 | static bool Remove(Concatenator * concatenator , IWriterFilter* |

| | |
|---|---|
| | filter); |
| 508 | private: |

| | |
|---|---|
| 509 | ReadStatus GetInputBuffers(list<Buffer*>& inputBuffers, bool& |

isLeftOver, bool& ignoreLeftOver);

| | |
|---|---|
| 510 | ReadStatus ReadFromMiddleFilter(Buffer*& buffer, UINT pinId, |

IMiddleFilter*& middleFilter);

| | |
|---|---|
| 511 | void WriteBuffersToAllWriters(list<Buffer*> inputBuffer); |
| 512 | void WriteBuffersToAllMiddleFilters(list<Buffer*> inputBuffer, |

IMiddleFilter* currentMiddleFilter, Buffer*& outputBuffer);

| | |
|---|---|
| 513 | bool IsInputFork( ); |
| 514 | bool IsOutputFork( ); |

| | |
|---|---|
| 515 | private: |

| | |
|---|---|
| 516 | UINT concatenatorId_; |
| 517 | map<UINT, IReaderFilter*> readerFilterInputPins_; |
| 518 | map<UINT, Concatenator *> concatenatorInputPins_; |
| 519 | map<UINT, IMiddleFilter*> middleFilterOutputPins_; |
| 520 | map<UINT, IWriterFilter*> writerFilterOutputPins_; |

| | |
|---|---|
| 521 | }; |

Lines 495-521: These lines define the concatenator class. The concatenator is the “glue” that joins the filters one to another, to transmit a buffers stream from one filter another.

### APPENDIX D: GRAPHS

The listing below provides definitions for class objects for a Buffer. Notes appear after the listing.

| | |
|---|---|
| 522 | class IExternalClock |
| 523 | { |
| 524 | public: |

| | |
|---|---|
| 525 | virtual ~IExternalClock( ) { } |
| 526 | virtual bool GetPosition(TimeCode& position, TimeCode::TCUnits |

units = TimeCode::TC_UNITS_MS) = 0;

| | |
|---|---|
| 527 | virtual bool IsRunning( ) = 0; |

| | |
|---|---|
| 528 | }; |
| 529 | class IGraph : public IExternalClock |
| 530 | { |
| 531 | public: |

| | |
|---|---|
| 532 | enum GRAPH_STATE |
| 533 | { |

| | |
|---|---|
| 534 | ASM_UNINITIALIZED, |
| 535 | ASM_INITIALIZED, |
| 536 | ASM_PREPARING, |
| 537 | ASM_PREPARED, |
| 538 | ASM_WORKING, |
| 539 | ASM_PAUSED, |
| 540 | ASM_STOPPING, |
| 541 | ASM_STOPPED, |
| 542 | ASM_UNPREPARING |

| 543 | }; | |
|---|---|---|
| 544 | virtual ~IGraph( ) { } | |
| 545 | virtual Dtk::TString GetLastError(bool detailed = false) = 0; | |
| 546 | virtual const VDDMFormat& GetGraphFormat( ) = 0; | |
| 547 | virtual bool | Prepare( ) = 0; |
| 548 | virtual bool | Unprepare( ) = 0; |
| 549 | virtual bool | Start( ) = 0; |
| 550 | virtual bool | Stop( ) = 0; |
| 551 | virtual bool | Abort( ) = 0; |

| | |
|---|---|
| 552 | virtual bool SetPosition(const TimeCode& position, |

TimeCode::TCUnits units = TimeCode::TC_UNITS_MS) = 0;

| | |
|---|---|
| 553 | virtual GRAPH_STATE GetState( ) = 0; |

| | |
|---|---|
| 554 | }; |
| 555 | class OutputEDLGraph : public IRealTimeGraph |
| 556 | { |
| 557 | public: |

| | |
|---|---|
| 558 | OutputEDLGraph(const VDDMChannel& channel, |

| 559 | | const TimeCode& bufferSize = |
|---|---|---|
| | VDDM_BUFFER_SIZE_MIN, | |
| 560 | | int bufferCacheSize = |
| | VDDM_BUFFER_CACHE_STANDARD, | |
| 561 | | const TimeCode& filePrefetchSize = MTC(2000, |
| | NULL), | |
| 562 | | TimeCode::TCUnits units = |
| | TimeCode::TC_UNITS_MS, | |
| 563 | | QWORD playbackOptions = |
| | VDDM_DEFAULT_AUDIO_EDIT_OPTION, | |
| 564 | | list<DWORD>* allowedEffects = NULL, |
| 565 | | VDDMFactory* ddmFactory = NULL, |
| 566 | | bool createTracksIfNotExists = false, |
| 567 | | MeterMethod meterMethod = MM_PEAK, |
| 568 | | int firstTrackId = 1, |
| 569 | | Demuxer::DemuxerMap* firstTrackRouting = NULL, |
| 570 | | IExternalClock *externalClock = NULL, |
| 571 | | HANDLE hStartStream = NULL, |
| 572 | | HANDLE hStopStream = NULL); |

| | |
|---|---|
| 573 | virtual ~OutputEDLGraph( ); |
| 574 | virtual const VDDMFormat& GetGraphFormat( ) { return |

masterFormat_; }

| | | |
|---|---|---|
| 575 | virtual bool | Prepare( ); |
| 576 | virtual bool | Unprepare( ); |
| 577 | virtual bool | Start( ); |
| 578 | virtual bool | Stop( ); |
| 579 | virtual bool | Abort( ); |
| 580 | virtual bool | Pause( ); |
| 581 | virtual bool | Resume( ); |
| 582 | virtual bool | GetPosition(TimeCode& position, |

TimeCode::TCUnits units = TimeCode::TC_UNITS_MS);

| | | |
|---|---|---|
| 583 | virtual bool | SetPosition(const TimeCode& position, |

TimeCode::TCUnits units = TimeCode::TC_UNITS_MS);

| | |
|---|---|
| 584 | virtual GRAPH_STATE GetState( ); |
| 585 | virtual bool PrepareSegment( |

| | |
|---|---|
| 586 | const Dtk::String& id, |
| 587 | const Dtk::TString& fileName, |
| 588 | TimeCode beginOffset = TimeCode::zero_, |
| 589 | TimeCode endOffset = TimeCode::zero_, |
| 590 | list<DDMEffectSettingPtr> segmentEffects = |

list<DDMEffectSettingPtr>( ),

| | |
|---|---|
| 591 | Demuxer::DemuxerMap* segmentChannelsRouting = NULL); |

| | |
|---|---|
| 592 | virtual bool CueSegment( |

| | |
|---|---|
| 593 | const Dtk::String& id, |
| 594 | TimeCode position, |
| 595 | const Dtk::String& afterId , |
| 596 | bool noCueBeforePlayhead, |
| 597 | const TimeCode& fadeIn = TimeCode::zero_, |
| 598 | const TimeCode& fadeOut = TimeCode::zero_, |
| 599 | float gain = 0, |
| 600 | VolumeCurve::VolumeCurveArray& volumeCurve = |

VolumeCurve::EmptyCurve( ),

| | |
|---|---|
| 601 | TimeCode::TCUnits units= TimeCode::TC_UNITS_MS, |
| 602 | HANDLE startPlayEvent = NULL, |
| 603 | HANDLE endPlayEvent = NULL, |
| 604 | HANDLE errorWhilePlayingEvent = NULL, |
| 605 | int * trackIndex = NULL, |
| 606 | TimeCode * startPosition = NULL, |
| 607 | TimeCode * endPosition = NULL, |
| 608 | TimeCode * currentPosition = NULL, |
| 609 | HANDLE errorRecoverdWhilePlayingEvent = NULL); |

| | |
|---|---|
| 610 | bool RemoveSegment(const Dtk::String& id); |
| 611 | bool UnCueSegment(const Dtk::String& id); |
| 612 | bool SetSpeed(OBJECT_TYPE objectType, |

| | |
|---|---|
| 613 | const Dtk::String& objectId, |
| 614 | float tempo, |
| 615 | bool keepPitch = false, |
| 616 | bool forceRefresh = false, |
| 617 | const TimeCode& referencePosition = GTC(−1)); |

| | |
|---|---|
| 618 | float GetSpeed( ) const {return lastStreamSpeed_;} |
| 619 | bool RemoveTrack(int trackIndex); |

| | |
|---|---|
| 620 | protected: |

| | |
|---|---|
| 621 | TimeCode bufferSize_; |
| 622 | VDDMFormat masterFormat_; |

| | |
|---|---|
| 623 | private: |

| | |
|---|---|
| 624 | bool BuildGraph( ); |
| 625 | void LoadBuffers( ); |

| | |
|---|---|
| 626 | }; |
| 627 | class InputEDLGraph : public IRealTimeGraph |
| 628 | { |
| 629 | public: |
| 630 | |

| | |
|---|---|
| 631 | InputEDLGraph(WORD channelId, |
| 632 | const VDDMFormat& driverFormat, |
| 633 | const TimeCode& bufferSize = VDDM_BUFFER_SIZE_MIN, |
| 634 | const Dtk::TString& audioDriver = _T(“”), |
| 635 | TimeCode::TCUnits units=TimeCode::TC_UNITS_MS, |
| 636 | QWORD recordingOptions = VDDM_DEFAULT_REC_OPTION, |
| 637 | VDDMFactory* ddmFactory = NULL, |
| 638 | DigiRecorderGraph::InputSource inputSource = |

DigiRecorderGraph::DEFAULT,

| 639 | MeterMethod meterMethod = MM_PEAK); | |
|---|---|---|
| 640 | virtual ~InputEDLGraph( ); | |
| 641 | bool SetDriverFormat(const VDDMFormat& driverFormat); | |
| 642 | virtual bool | Prepare( ); |
| 643 | virtual bool | Unprepare( ); |
| 644 | virtual bool | Start( ); |
| 645 | virtual bool | Stop( ); |
| 646 | virtual bool | Abort( ); |
| 647 | virtual bool | Pause( ); |
| 648 | virtual bool | Resume( ); |
| 649 | virtual bool | GetPosition(TimeCode& position, |

TimeCode::TCUnits units = TimeCode::TC_UNITS_MS );

| | | |
|---|---|---|
| 650 | virtual bool | SetPosition(const TimeCode& position, |

TimeCode::TCUnits units = TimeCode::TC_UNITS_MS);

| | |
|---|---|
| 651 | virtual GRAPH_STATE GetState( ); |
| 652 | virtual bool IsRunning( ); |

| | |
|---|---|
| 653 | protected: |

| | |
|---|---|
| 654 | bool AddSegment(const Dtk::TString& targetFileName, |

| | |
|---|---|
| 655 | const VDDMFormat& targetFormat, |
| 656 | TimeCode startPosition = TimeCode::zero_, |
| 657 | TimeCode duration = VDDM_DURATION_INFINITE, |
| 658 | TimeCode::TCUnits units = TimeCode::TC_UNITS_MS, |
| 659 | const Dtk::TString& afterFile = _T(“”), |
| 660 | HANDLE hJobStartedEvent = NULL, |
| 661 | HANDLE hJobEndedEvent = NULL, |
| 662 | HANDLE hFileClosedEvent = NULL, |
| 663 | bool isSensitiveLevelRecordingJob = false, |
| 664 | bool createVolFile = true, |
| 665 | DWORD fileCreationFlags = WRITE_NOFLAG); |

| | |
|---|---|
| 666 | bool RemoveSegment(const Dtk::TString& fileName); |
| 667 | bool StopSegment(const Dtk::TString& fileName);\/ |
| 668 | bool ModifySegment(const Dtk::TString& fileName, |

| | |
|---|---|
| 669 | TimeCode newStartPosition = NO_CHANGE, |
| 670 | TimeCode newDuration = NO_CHANGE, |
| 671 | TimeCode::TCUnits units = |

| | |
|---|---|
| | TimeCode::TC_UNITS_MS); |
| 672 | protected: |

| | |
|---|---|
| 673 | WORD channelId_; |
| 674 | VDDMFormat driverFormat_; |
| 675 | bool BuildGraph( ); |
| 676 | void DestroyGraph( ); |

| | |
|---|---|
| 677 | }; |

Lines 522-528: These lines define the IExternalClock, which defines any device that provides time-sampling.
Lines 529-554: These lines define the IGraph object; namely, a container for filters that allows control of a buffer's stream transport using methods such as Start/Stop/Pause.
Lines 555-626: These lines define the OutputEDLGraph class, for streaming input sources through an output device, such as a sound card or a display device.
Lines 627-677: These lines define the InputEDLGraph class, which is responsible for streaming data from an input device, such as a sound card or a video camera, into an output storage such as a digital-encoded file.

What is claimed is:

1. A system for processing audio, comprising:
a filter instantiator, for instantiating at least one filter, wherein each filter is configured to process at least one audio buffer wherein an audio buffer comprises raw audio data and auxiliary data, to retrieve auxiliary data from at least one audio buffer, and to store auxiliary data in at least one audio buffer;
a concatenator instantiator, for instantiating at least one concatenator, wherein each concatenator is configured to transmit at least one audio buffer from one filter to another filter, to retrieve at least one audio buffer from a shared buffer cache, and to store at least one audio buffer in the shared buffer cache;
a processing graph instantiator, for instantiating a processing graph comprising the at least one filter instantiated by said filter instantiator and the at least one concatenator instantiated by said concatenator instantiator, wherein the processing graph is configured to transmit audio buffers processed by filters in the graph from one filter to another filter in accordance with the at least one concatenator; and
a graph processor, (i) for applying the processing graph instantiated by said processing graph instantiator to at least one audio buffer extracted from an incoming audio stream, (ii) for storing intermediate processing results of at least one of the filters as auxiliary data in at least one audio buffer, and (iii) for storing at least one of the audio buffers that comprise auxiliary data stored therein by filters, in a buffer cache that is shared among the filters in the processing graph.

2. The system of claim 1 wherein the at least one filter instantiated by said filter instantiator comprises a reader filter, for extracting the at least one audio buffer from the incoming stream for said graph processor.

3. The system of claim 1 wherein the at least one filter instantiated by said filter instantiator comprises a writer filter, for writing at least one audio buffer from to a memory shared with a sound card.

4. The system of claim 1 wherein at least one concatenator is configured to bypass a filter if the output of that filter is already stored in the buffer cache.

5. The system of claim 1 wherein at least one filter is configured to bypass a portion of processing an audio buffer of the result of that portion of processing is already stored in the audio buffer as auxiliary data.

6. The system of claim 1 wherein said processing graph instantiator dynamically adds at least one filter to the processing graph, thereby generating an updated processing graph, and wherein said graph processor dynamically applies the updated processing graph to subsequent audio buffers extracted from the incoming audio stream.

7. The system of claim 1 wherein said processing graph instantiator dynamically adds at least one concatenator to the processing graph, thereby generating an updated processing graph, and wherein said graph processor dynamically applies the updated processing graph to subsequent audio buffers extracted from the incoming audio stream.

8. The system of claim 1 wherein said processing graph instantiator dynamically removes at least one filter from the processing graph, thereby generating an updated processing graph, and wherein said graph processor dynamically applies the updated processing graph to subsequent audio buffers extracted from the incoming audio stream.

9. The system of claim 1 wherein said processing graph instantiator dynamically removes at least one concatenator from the processing graph, thereby generating an updated processing graph, and wherein said graph processor dynamically applies the updated processing graph to subsequent audio buffers extracted from the incoming audio stream.

10. The system of claim 1 wherein said processing graph instantiator dynamically changes at least one filter in the processing graph, thereby generating an updated processing graph, and wherein said graph processor dynamically applies the updated processing graph to subsequent audio buffers extracted from the incoming audio stream.

11. The system of claim 1 wherein said processing graph instantiator dynamically changes at least one concatenator in the processing graph, thereby generating an updated processing graph, and wherein said graph processor dynamically applies the updated processing graph to subsequent audio buffers extracted from the incoming audio stream.

12. A non-transient computer-readable storage medium for storing instructions which, when executed by a computer processor, cause the processor:
to instantiate at least one filter, wherein each filter is configured to process at least one audio buffer wherein an audio buffer comprises raw audio data and auxiliary data, to retrieve auxiliary data from at least one audio buffer, and to store auxiliary data in at least one audio buffer;
to instantiate at least one concatenator, wherein each concatenator is configured to transmit at least one audio buffer from one filter to another filter, to retrieve at least one audio buffer from a shared buffer cache, and to store at least one audio buffer in the shared buffer cache;
to instantiate a processing graph comprising the at least one instantiated filter and the at least one instantiated concatenator, wherein the processing graph is configured to transmit audio buffers processed by filters in the graph from one filter to another filter in accordance with the at least one concatenator;
to extract at least one audio buffer from an incoming audio stream;
to apply the instantiated processing graph to the at least one extracted audio buffer;
to store intermediate processing results of at least one of the filters as auxiliary data in at least one audio buffer; and
to store at least one of the audio buffers that comprise auxiliary data stored therein by filters, in a buffer cache that is shared among the filters in the processing graph.

13. The computer-readable storage medium of claim 12 wherein at least one concatenator is configured to bypass a filter if the output of that filter is already stored in the buffer cache.

14. The computer-readable storage medium of claim 12 wherein at least one filter is configured to bypass a portion of processing an audio buffer if the result of that portion of processing is already stored in the audio buffer as auxiliary data.

15. The computer-readable storage medium of claim 12 wherein the stored instructions cause the processor:
to dynamically add at least one filter to the processing graph, thereby generating an updated processing graph; and
to dynamically apply the updated processing graph to subsequent audio buffers extracted from the incoming audio stream.

16. The computer-readable storage medium of claim 12 wherein the stored instructions cause the processor:
to dynamically add at least one concatenator to the processing graph, thereby generating an updated processing graph; and
to dynamically apply the updated processing graph to subsequent audio buffers extracted from the incoming audio stream.

17. The computer-readable storage medium of claim 12 wherein the stored instructions cause the processor:
to dynamically remove at least one filter from the processing graph, thereby generating an updated processing graph; and
to dynamically apply the updated processing graph to subsequent audio buffers extracted from the incoming audio stream.

18. The computer-readable storage medium of claim 12 wherein the stored instructions cause the processor:
to dynamically remove at least one concatenator from the processing graph, thereby generating an updated processing graph; and
to dynamically apply the updated processing graph to subsequent audio buffers extracted from the incoming audio stream.

19. The computer-readable storage medium of claim 12 wherein the stored instructions cause the processor:
to dynamically change at least one filter in the processing graph, thereby generating an updated processing graph; and
to dynamically apply the updated processing graph to subsequent audio buffers extracted from the incoming audio stream.

20. The computer-readable storage medium of claim 12 wherein the stored instructions cause the processor:
to dynamically change at least one concatenator in the processing graph, thereby generating an updated processing graph; and
to dynamically apply the updated processing graph to subsequent audio buffers extracted from the incoming audio stream.
